(19) United States
(12) Patent Application Publication
(10) Pub. No.: US 2019/0011947 A1
(43) Pub. Date: Jan. 10, 2019

(54) DISPLAY SETTING METHOD, PROGRAM, AND SYSTEM

(71) Applicant: SEIKO EPSON CORPORATION, Tokyo (JP)

(72) Inventors: Hironori NAKAZAWA, MATSUMOTO-SHI (JP); Masafumi SATO, HARA-MURA (JP); Michio NAKADAIRA, IKEDA-MACHI (JP); Yuki KIMPARA, KYOTO-SHI (JP); Masaaki NONOYAMA, KYOTO-SHI (JP); Masanori OJIMA, KYOTO-SHI (JP)

(73) Assignee: SEIKO EPSON CORPORATION, Tokyo (JP)

(21) Appl. No.: 16/021,764

(22) Filed: Jun. 28, 2018

(30) Foreign Application Priority Data
Jul. 10, 2017 (JP) 2017-134325

(51) Int. Cl. G06F 1/16; G06F 3/041; H04M 1/725

(52) U.S. Cl. CPC G06F 1/163; H04M 1/7253; G06F 3/0416; G06F 3/0412

(57) ABSTRACT

An information processing terminal displays a display setting screen on a touch panel on the basis of display setting information acquired from a wearable apparatus. Next, the information processing terminal generates display setting change information on the basis of a user's change operation on the display setting screen displayed on the touch panel. The information processing terminal transmits the display setting change information to the wearable apparatus from the information processing terminal.

### CROSS-REFERENCES TO RELATED APPLICATIONS

This application claims priority to Japanese Patent Application No. 2017-134325, filed Jul. 10, 2017, the entirety of which is herein incorporated by reference.

### BACKGROUND

### 1. Technical Field

The present invention relates to a display setting method, a program, and a system.

### 2. Related Art

In recent years, workouts may have been performed in a state of wearing a wearable apparatus having various sensors, such as a global positioning system (GPS) apparatus for a runner. A user may change a screen of a wearable apparatus. For example, JP-A-2006-284365 discloses a technique in which a case frame/dial plate display with electronic display and a time display with electronic display are performed on an electronic indicating portion provided to an upper part of a watch case of a wristwatch, and thus the dial plate portion of the watch case is designed to desired design.

However, in a case where setting of a display screen of a wearable apparatus is performed on the wearable apparatus, the setting may require the time and effort. For example, in a case where the wearable apparatus has only a plurality of buttons as an operation unit as in JP-A-2006-284365, it takes a long time to perform complex setting by using only the plurality of buttons. Specifically, in a case where the wearable apparatus has many setting items, many operations on any button or complex operations on combinations of the plurality of buttons are performed. Therefore, it takes time and effort for a user to set the wearable apparatus.

### SUMMARY

An advantage of some aspects of the invention is to easily perform setting of a display screen of a wearable apparatus.

An aspect of the invention relates to a display setting method of setting one or a plurality of display screens by using an information processing terminal which is able to communicate with a wearable apparatus which displays the one or plurality of display screens on the basis of measured data obtained in a sensor, the method including causing the information processing terminal to acquire display setting information regarding the one or plurality of display screens from the wearable apparatus; display a display setting screen for changing the content of the one or plurality of display screens on the basis of the display setting information; generate display setting change information on the basis of a user's change operation on the display setting screen; and transmit the display setting change information to the wearable apparatus from the information processing terminal.

In the aspect of the invention, since the display setting information is acquired from the wearable apparatus, it is possible to display a display setting screen in which a display screen changed by the user is reflected on a display unit of the information processing terminal.

In the aspect of the invention, the display setting information may be information regarding at least one of the content and a display aspect of the one display screen or each of the plurality of display screens.

According to the aspect with this configuration, the content and a display aspect of a display screen of the wearable apparatus can be displayed on the information processing terminal.

In the aspect of the invention, the display setting information may be information regarding at least one of orders, the content, and display aspects of the plurality of display screens which are switched according to the user's operation on an operation unit of the wearable apparatus.

According to the aspect with this configuration, orders, the content, and display aspects of a plurality of display screens of the wearable apparatus can be displayed on the information processing terminal.

In the aspect of the invention, the display setting information may include orders of the plurality of display screens which are switched according to the user's operation on an operation unit of the wearable apparatus, and the plurality of display screens which are switched according to operations performed by the user may be disposed in correlation with orders of the operations performed by the user in the display setting screen.

According to the aspect with this configuration, a plurality of display screens are disposed in correlation with orders of operations performed by the user, and thus a plurality of display screens to be displayed on the display unit of the wearable apparatus can be presented to the user to be easily understood. More specifically, if an operation is not performed in the wearable apparatus, the next display screen is not displayed, and thus the user cannot check a plurality of display screens simultaneously. On the other hand, since the information processing terminal displays a plurality of display screens to be disposed in correlation with orders of operations performed by the user, a plurality of display screen and orders of operations performed by the user can be checked by the user in a single screen, and can thus be presented to the user to be easily understood.

In the aspect of the invention, the operation unit of the wearable apparatus may include at least one of a button or a touch sensor, and the plurality of display screens may be disposed in correlation with the number of operating the operation unit in the display setting screen.

According to the aspect with this configuration, even in a case where the wearable apparatus includes at least one of a button or a touch sensor as the operation unit, a plurality of display screens switched according to the number of operations on the button or the touch sensor can be presented to the user to be easily understood. For example, in a case where the wearable apparatus includes a touch sensor, the information processing terminal displays a plurality of display screens to be disposed in correlation with the number of operations on the touch sensor. Therefore, a plurality of display screen and the number of operations on the touch sensor performed by the user can be checked by the user in a single screen, and can thus be presented to the user to be easily understood.

In the aspect of the invention, in a case where a change operation regarding at least one of orders, the content, and display aspects of the plurality of display screens is received, the display setting change information may be generated.

According to the aspect with this configuration, since the display setting change information is generated when the change operation is received, the display setting change information can be transmitted to the wearable apparatus faster than in a case where the display setting change information is generated when an instruction for transmitting the display setting change information is received through an operation of the user.

In the aspect of the invention, the wearable apparatus may measure a plurality of items indicating a state of the user, the one display screen or each of the plurality of display screens may include a first display region and a second display region, at least one item selected from among the plurality of items may be displayed in the first display region, at least one item which is different from the item displayed in the first display region and is selected from among the plurality of items may be displayed in the second display region, the display setting information may include first identification data for identifying the item displayed in the first display region and second identification data for identifying the item displayed in the second display region, the information processing terminal may display an image to be displayed in the first display region on the basis of the first identification data, the information processing terminal may display an image to be displayed in the second display region on the basis of the second identification data, the information processing terminal may display an image based on a plurality of item candidates of items which are able to be displayed in the first display region according to an operation on an operation unit of the information processing terminal, the first identification data may be updated such that an item selected from among the plurality of item candidates according to an operation on the operation unit of the information processing terminal is identified, and the display setting change information including the updated first identification data may be transmitted to the wearable apparatus.

According to the aspect with this configuration, the wearable apparatus can display an item desired by the user in the first display region among a plurality of items indicating a state of the user.

In the aspect of the invention, the plurality of item candidates may include at least an item regarding activity of the user or an item regarding an index obtained by analyzing the activity of the user.

According to the aspect with this configuration, the wearable apparatus can display an index obtained by analyzing the activity of the user in the display region.

In the aspect of the invention, a time point may be displayed in the first display region, and the plurality of item candidates may include a time point.

According to the aspect with this configuration, the wearable apparatus can display a time point in the first display region.

In the aspect of the invention, a lap may be displayed in the first display region, the lap may be a movement distance of the wearable apparatus per unit time, the time required for movement of the wearable apparatus per unit distance, or a number of each of a plurality of predefined running sections, and the plurality of item candidates may include the lap.

According to the aspect with this configuration, the wearable apparatus can display a lap in the first display region.

In the aspect of the invention, the display setting information may be information regarding the content of the one or plurality of display screens, and a simulation image simulating the wearable apparatus and an image indicating the content included in the display setting information may be displayed.

According to the aspect with this configuration, the information processing terminal displays a simulation image simulating the wearable apparatus, and thus displays the image closer to a state of the wearable apparatus of when the display setting information is changed. Therefore, the user views the image displayed on the display unit of the information processing terminal, and thus the user can more easily imagine a state of the wearable apparatus of when the display setting information is changed.

In the aspect of the invention, the display setting information may be information regarding the content and a display aspect of the one display screen or each of the plurality of display screens, and a display aspect of the simulation image may be set by using a display aspect included in the display setting information.

According to the aspect with this configuration, the information processing terminal displays a simulation image of which a display aspect is set by using a display aspect included in the display setting information, and thus displays an image closer to a state of the wearable apparatus of when the display setting information is changed. Therefore, the user views the image displayed on the display unit of the information processing terminal, and can thus more easily imagine a state of the wearable apparatus of when the display setting information is changed than in a case where an image simulating a display aspect is not displayed.

### BRIEF DESCRIPTION OF THE DRAWINGS

The invention will be described with reference to the accompanying drawings, wherein like numbers reference like elements.

FIG. 1 is a diagram illustrating a system according to the present embodiment.

FIG. 2 is a diagram illustrating switching between display screens in a wearable apparatus.

FIG. 3 is a diagram illustrating a hardware configuration of the wearable apparatus.

FIG. 4 is a diagram illustrating a hardware configuration of an information processing terminal.

FIG. 5 is a diagram illustrating a functional configuration example of the information processing terminal.

FIG. 6 is a flowchart illustrating a my device screen display process.

FIG. 7 is a flowchart illustrating an activity amount display setting process.

FIG. 8 is a flowchart illustrating a workout display setting process.

FIG. 9 is a flowchart illustrating a measurement display setting process.

FIG. 10 is a diagram illustrating a my device screen.

FIG. 11 is a diagram illustrating an activity amount display setting screen.

FIG. 12 is a diagram illustrating a workout display setting screen.

FIG. 13 is a diagram illustrating a measurement display setting screen.

FIG. 14 is a diagram (first) illustrating an example of changing a selection item in a display content changing menu.

FIG. 15 is a diagram (second) illustrating an example of changing a selection item in the display content changing menu.

FIG. 16 is a diagram (first) illustrating changing of a display region.

FIG. 17 is a diagram (second) illustrating changing of a display region.

FIG. 18 is a diagram illustrating changing of a display region when a face is switched.

FIG. 19 is a diagram illustrating item candidates corresponding to a workout.

FIG. 20 is a diagram illustrating first Modification Example of a measurement display setting screen.

FIG. 21 is a diagram illustrating second Modification Example of a measurement display setting screen.

### DESCRIPTION OF EXEMPLARY EMBODIMENTS

Hereinafter, embodiments of the invention will be described in detail. The present embodiment described below is not intended to improperly limit the content of the invention disclosed in the appended claims. All constituent elements described below are not essential constituent elements of the invention.

### A. Embodiment

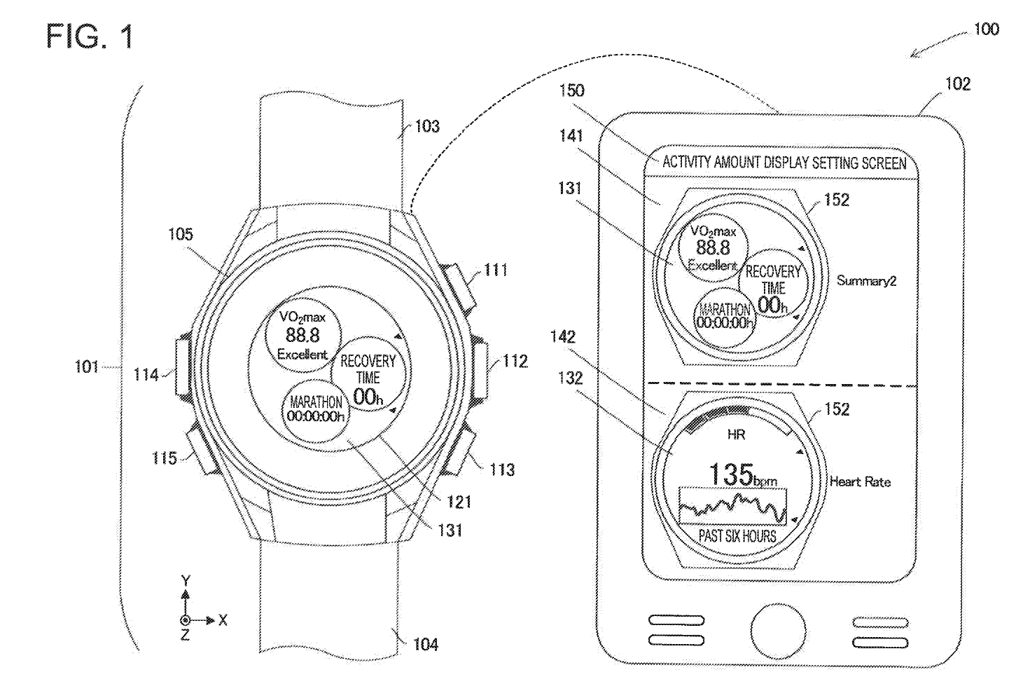

FIG. 1 is a diagram illustrating a system 100 according to the present embodiment. As illustrated in FIG. 1, the system 100 includes a wearable apparatus 101, and an information processing terminal 102 which can perform communication with the wearable apparatus 101. In the system 100, one or a plurality of display screens of wearable apparatus 101 can be set by using the information processing terminal 102.

The wearable apparatus 101 is an apparatus mounted on the body of a user U. For example, the wearable apparatus 101 is a wrist apparatus mounted on the wrist of the user U. As illustrated in FIG. 1, the wearable apparatus 101 has the same appearance as that of a wristwatch. The wearable apparatus 101 includes a first band 103, a second band 104, a case portion 105, a first operation button 111, a second operation button 112, a third operation button 113, a fourth operation button 114, a fifth operation button 115, and a display unit 121. Hereinafter, the first operation button 111 to the fifth operation button 115 will be collectively referred to as “operation buttons 111 to 115” in some cases.

The first band 103 and the second band 104 are bands used to mount the wearable apparatus 101 on the wrist of the user U. The case portion 105 is a casing of the wearable apparatus 101.

The operation buttons 111 to 115 are provided on side surfaces of the wearable apparatus 101. The first operation button 111 is substantially located in the direction of two o'clock, the second operation button 112 is substantially located in the direction of three o'clock, and the third operation button 113 is substantially located in the direction of four o'clock. The fourth operation button 114 is substantially located in the direction of nine o'clock, and the fifth operation button 115 is substantially located in the direction of eight o'clock. The display unit 121 is provided at the center of the front face of the wearable apparatus 101.

In a case where a display surface side of the display unit 121 is assumed to be a front surface, a direction directed from a rear surface toward the front surface, that is, a normal direction to the display surface is set to a positive Z axis direction. Two axes orthogonal to the Z axis are set to XY axes, and a direction from the center of the display unit 121 toward the second operation button 112 is set to a positive X axis direction.

The wearable apparatus 101 is configured to be able to perform communication with the information processing terminal 102. For example, the wearable apparatus 101 may be connected to the information processing terminal 102 in a wirelessly manner through short-range radio communication. The short-range radio communication here may employ various forms such as Bluetooth (registered trademark), near field radio communication (NFC), or ANT+. Alternatively, the wearable apparatus 101 may be connected to the information processing terminal 102 in a wired manner via a connection cable such as a Universal Serial Bus (USB) cable, or a cradle.

The wearable apparatus 101 may measure values regarding one or more workouts. Here, the workouts refer to overall exercise. The workouts are, for example, a run, a walk, biking, and a swim. The run is subdivided and is handled. For example, typical running, a trail run, and running on a treadmill may be handled as different workouts depending on running environments. Alternatively, typical running, a trail run, and running on a treadmill may be handled as a single workout. In the workouts, various sports such as a tennis, a soccer, and skiing may be handled as different types in one aspect, and may be handled as the same type in another aspect. In a triathlon, three competitions such as a run, biking, and a swim are played, and thus the run, biking, and the swim may be handled as three workouts in one aspect, and may be handled as a single workout in another aspect.

The information processing terminal 102 is a terminal such as a smart phone or a tablet terminal. The information processing terminal 102 may set a display screen which is displayed on the wearable apparatus 101 by executing application software.

The display unit 121 of the wearable apparatus 101 illustrated in FIG. 1 displays an activity amount display screen 131 on which an activity amount is displayed as an example of a display screen. In a case where the user U's pressing operation on the first operation button 111 is detected, the wearable apparatus 101 displays the next activity amount display screen. As mentioned above, the wearable apparatus 101 can switch a plurality of display screens through a pressing operation on any of the operation buttons 111 to 115. On the other hand, the information processing terminal 102 illustrated in FIG. 1 displays an activity amount display setting screen 150 (an example of a display setting screen).

The activity amount display setting screen 150 includes an activity amount display simulation screen 141 and an activity amount display simulation screen 142. The activity amount display simulation screen 141 has the same image as that of the activity amount display screen 131 which is currently displayed on the wearable apparatus 101. On the other hand, the activity amount display simulation screen 142 has the same image as that of an activity amount display screen displayed after the first operation button 111 is operated in a state in which the activity amount display screen 131 is displayed in the wearable apparatus 101. Therefore, even if the first operation button 111 is not pressed, the user U can check the content of the current activity amount display screen 131 and the content of an activity amount display screen after the first operation button 111 is pressed by using the information processing terminal 102.

Here, the activity amount display simulation screen 141 is an image in which the activity amount display screen 131 is superimposed on a simulation image 152, and the activity amount display simulation screen 142 is an image in which an activity amount display screen 132 is superimposed on the simulation image 152. The simulation image 152 is an image simulating the wearable apparatus 101. As mentioned above, the information processing terminal 102 displays the image including the activity amount display screens 131 and 132 displayed in the wearable apparatus 101, and thus provides the same user interface (UI) as that of the wearable apparatus 101 to the user U. Here, the image in which the display screen is superimposed on the simulation image may be an image in which the display screen is disposed at a position of the simulation image simulating the wearable apparatus 101, corresponding to the display unit 121. Alternatively, the image in which the display screen is superimposed on the simulation image may be an image in which the display screen is displayed with the simulation image as the background.

The information processing terminal 102 receives the user U's change operation such as replacing orders of the activity amount display simulation screens 141 and 142 with each other, adding a new activity amount display simulation screen between the activity amount display simulation screens 141 and 142, or deleting either of the activity amount display simulation screens 141 and 142. The information processing terminal 102 reflects display setting in which the change operation is reflected, in the wearable apparatus 101. Through the process, the information processing terminal 102 can set a display screen of the wearable apparatus 101.

The user U can perform an operation with the higher degree of freedom in the information processing terminal 102 than in the wearable apparatus 101, and can thus easily set a display screen of the wearable apparatus 101. The information processing terminal 102 can provide the same UI as a UI of the wearable apparatus 101 to the user U in order to display a display screen displayed on the display unit 121 of the wearable apparatus 101. The information processing terminal 102 makes it possible to easily imagine a state after a display screen of the wearable apparatus 101 is set by using the simulation image 152, and can thus realize setting of a display screen of the wearable apparatus 101 in which a use state of the wearable apparatus 101 is generated as an image.

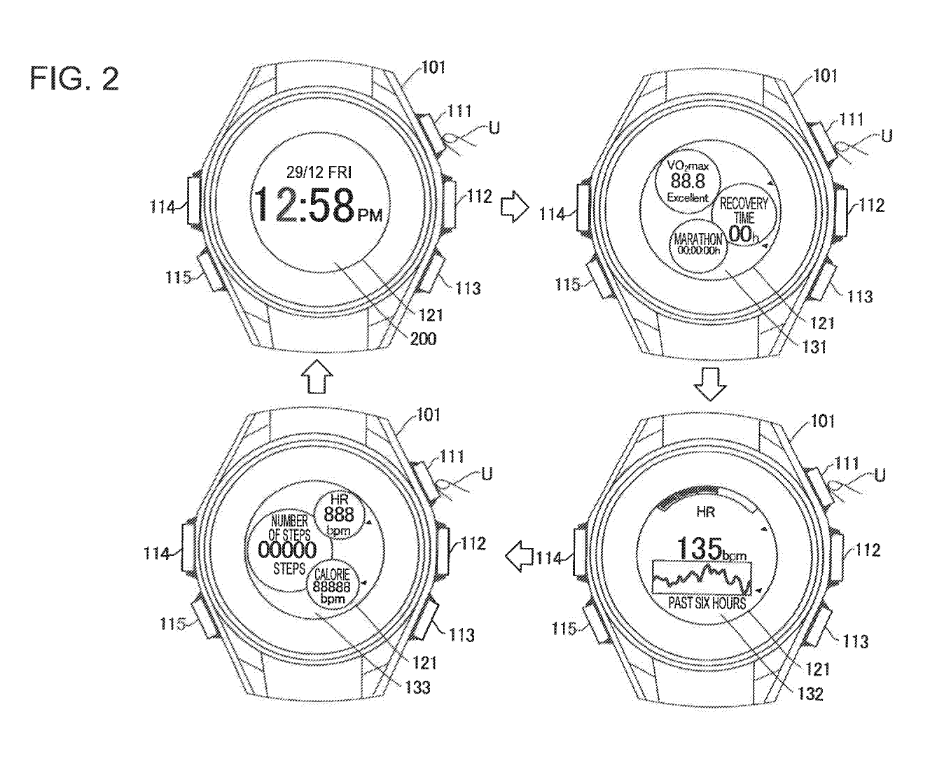

FIG. 2 illustrates switching between display screens in the wearable apparatus 101. The wearable apparatus 101 illustrated on the upper left part in FIG. 2 displays a watch screen 200. The watch screen 200 displays a time point. In a case where the user U presses the first operation button 111 in a state in which the watch screen 200 is displayed on the display unit 121, the wearable apparatus 101 displays the activity amount display screen 131 as illustrated on the upper right part in FIG. 2.

In a case where the user U presses the first operation button 111 in a state in which the activity amount display screen 131 is displayed, the wearable apparatus 101 displays the activity amount display screen 132 as illustrated on the lower right part in FIG. 2. In a case where the user U presses the first operation button 111 in a state in which the activity amount display screen 132 is displayed, the wearable apparatus 101 displays an activity amount display screen 133 as illustrated on the lower left part in FIG. 2. In a case where the user U presses the first operation button 111 in a state in which the activity amount display screen 133 is displayed, the wearable apparatus 101 returns to the state of displaying the watch screen 200. The maximum oxygen intake (VO₂max), a recovery time, and an elapse time in marathon are displayed on the activity amount display screen 131. A heart rate per unit time (hereinafter, simply referred to as a “heart rate”), and a graph indicating transition in a heart rate for past six hours are displayed on the activity amount display screen 132. The number of steps, a heart rate, and calorie consumption are displayed on the activity amount display screen 133.

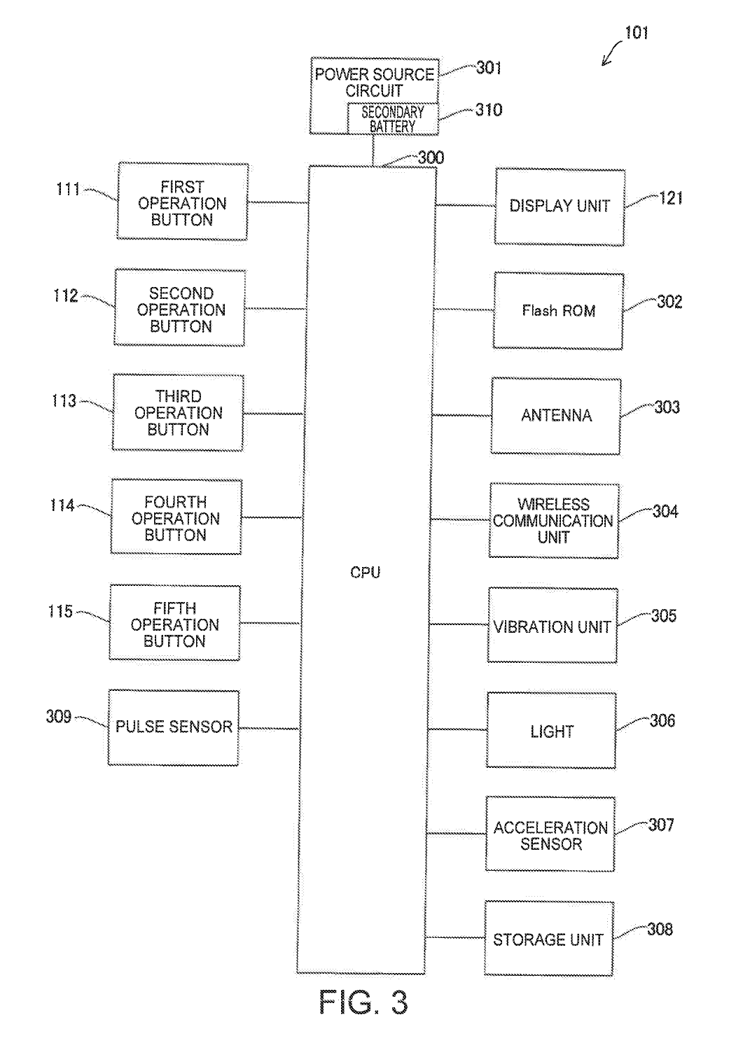

FIG. 3 is a diagram illustrating a hardware configuration of the wearable apparatus 101. As illustrated in FIG. 3, the wearable apparatus 101 includes a central processing unit (CPU) 300, a power source circuit 301, the display unit 121, a flash ROM 302, an antenna 303, a wireless communication unit 304, a vibration unit 305, a light 306, an acceleration sensor 307, and a storage unit 308. The wearable apparatus 101 includes the operation buttons 111 to 115 and a pulse sensor 309. The power source circuit 301, the display unit 121, the flash ROM 302, the storage unit 308, the operation buttons 111 to 115, and the pulse sensor 309 are connected to the CPU 300. The power source circuit 301 has a secondary battery 310.

The CPU 300 is a control device (a control unit or a processing unit) controlling the wearable apparatus 101. Specifically, the CPU 300 includes a memory storing a program, and performs a process of generating time information based on a global positioning system (GPS), a process of storing a traveling state of the user U, a speed calculation process, and the like. The display unit 121 displays an image based on measured data which is measured by the sensors. The sensors are sensors in the wearable apparatus 101, that is, the acceleration sensor 307, the pulse sensor 309, and the like.

The power source circuit 301 is electrically connected to the CPU 300, and charges the secondary battery 310 in a case of being connected to an AC adaptor. The secondary battery 310 supplies drive power to the display unit 121, the antenna 303, and the like. The display unit 121 displays a watch screen, and an image based on information corresponding to an operation mode of the wearable apparatus 101. The flash ROM 302 is electrically connected to the CPU 300, and a nonvolatile memory of which the content is not lost even if a power source is turned off. The flash ROM 302 stores firmware of the wearable apparatus 101.

The antenna 303 is electrically connected to the CPU 300, and acquires satellite information such as GPS time information or position information by using, for example, satellite signals. The wireless communication unit 304 is electrically connected to the CPU 300, and performs wireless communication with the information processing terminal 102. The vibration unit 305 is electrically connected to the CPU 300, and is a device notifying the user U of a warning or the like through vibration. The light 306 is electrically connected to the CPU 300, and irradiates the display unit 121 during measurement, for example. The acceleration sensor 307 is electrically connected to the CPU 300, and is a sensor measuring accelerations in three-axis directions. The storage unit 308 is electrically connected to the CPU 300, and a work memory used by the CPU 300.

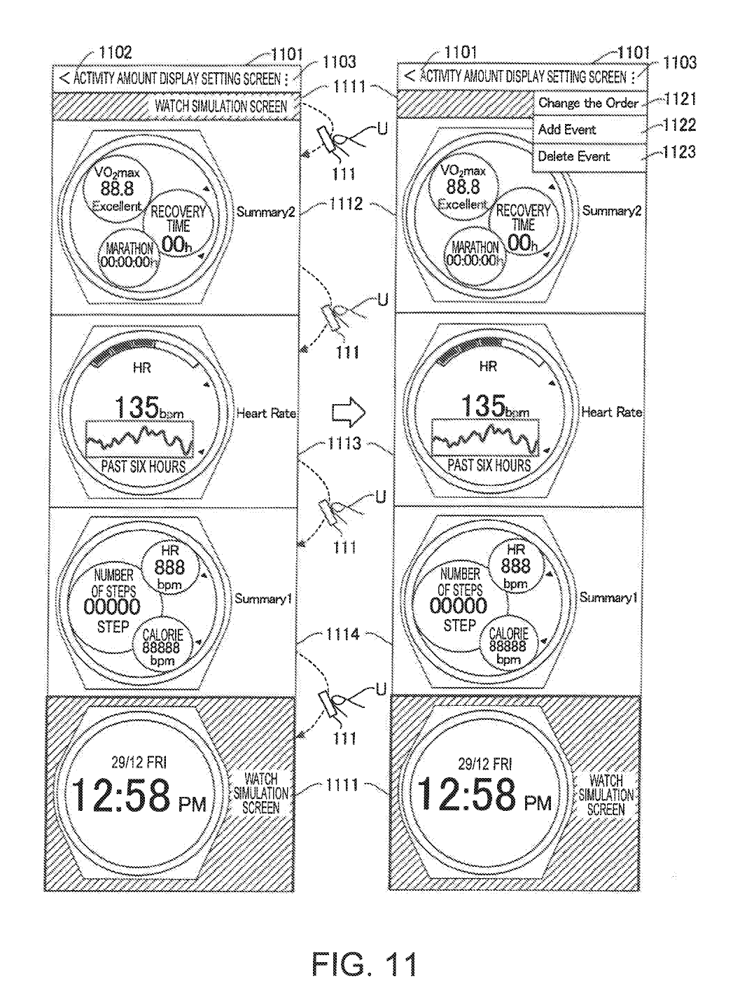

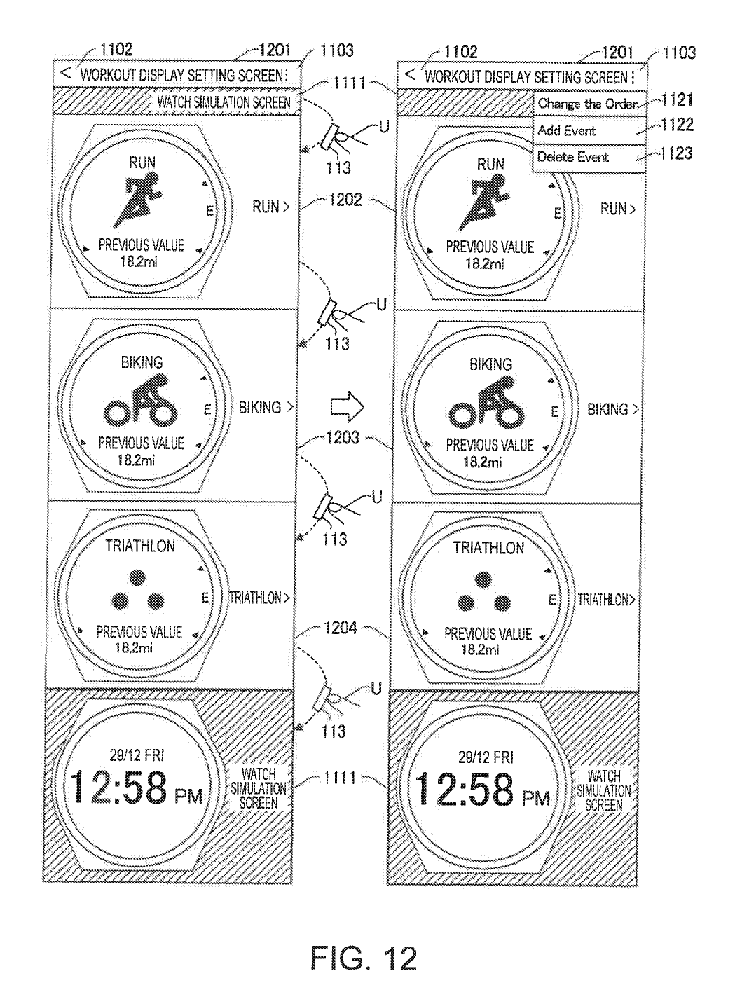

The operation buttons 111 to 115 are electrically connected to the CPU 300, and detects a pressing operation performed by the user U. In a case where the user U presses the first operation button 111, the wearable apparatus 101 displays an activity amount display screen displaying an activity amount, on the display unit 121. The information processing terminal 102 sets an activity amount display screen on an activity amount display setting screen illustrated in FIG. 11. “Summary2”, “Heart Rate”, and “Summary1” illustrated in FIG. 11 are examples of activity amount display screens to be displayed on the display unit 121. The activity amount display screens are sequentially switched if the first operation button 111 is pressed. In a case where the User U presses the second operation button 112, the wearable apparatus 101 displays a menu screen for setting a function of the wearable apparatus 101 on the display unit 121. In a case where the user U presses the third operation button 113, the wearable apparatus 101 displays a workout display screen on the display unit 121 if the wearable apparatus 101 copes with a plurality of workouts. The information processing terminal 102 sets a workout display screen on a workout display setting screen illustrated in FIG. 12. “Run”, “Biking”, and “Triathlon” illustrated in FIG. 12 are examples of workout display screens to be displayed on the display unit 121. The workout display screens are sequentially switched if the third operation button 113 is pressed.

In a case where the user U presses the fourth operation button 114, the wearable apparatus 101 displays, for example, a watch screen on the display unit 121 if an activity amount display screen is displayed. In a case where the user U presses the fifth operation button 115, the wearable apparatus 101 performs, for example, GPS positioning.

The pulse sensor 309 is communicably connected to the CPU 300, and outputs a pulse signal. For example, the pulse sensor 309 includes a light emitting portion, a light receiving portion, an amplifier, a band-pass filter, and an A/D converter. Light emitted from the light emitting portion is reflected from a human tissue such as a blood vessel, and is incident to the light receiving portion. The light receiving portion generates a signal having undergone photoelectric conversion, that is, a pulse signal. The A/D converter performs A/D conversion on the signal output from the light receiving portion so as to generate pulse signal data, and outputs the generated pulse signal data to the CPU 300. Since an amount of light from the light emitting portion absorbed by hemoglobin or the like contained in blood flowing through a blood vessel of a living body changes in conjunction with heartbeats, an amount of light incident to the light receiving portion is proportional to the propagation of the heartbeats, that is, pulses. The CPU 300 calculates a pulse rate, a pulse interval (R-R interval), and a pulse change (HRV) of the user U on the basis of the pulse signal output from the pulse sensor 309 or pulse signal data into which the pulse signal is digital-switched.

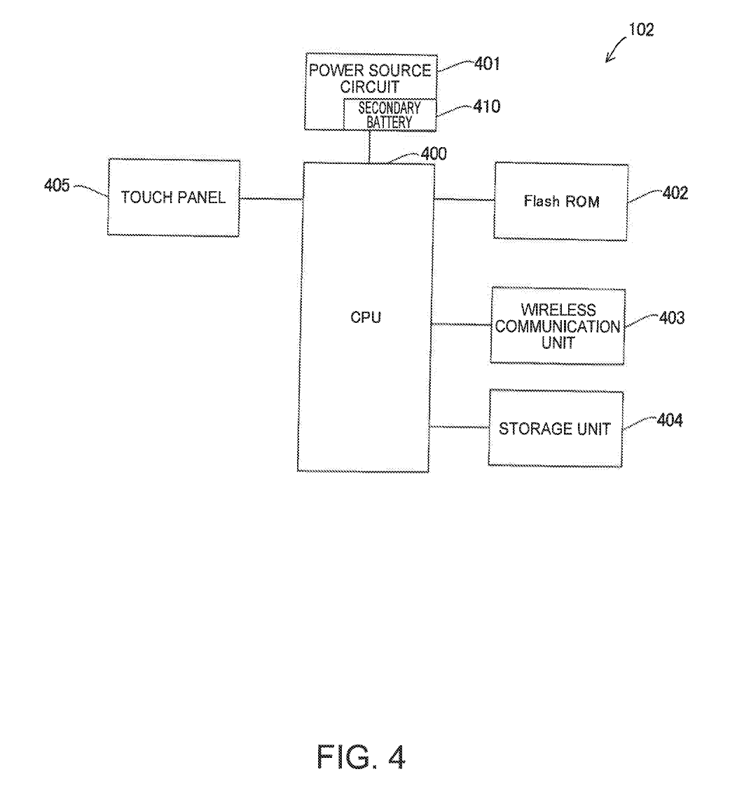

FIG. 4 is a diagram illustrating a hardware configuration of the information processing terminal 102. The information processing terminal 102 includes a CPU 400, a power source circuit 401, a flash ROM 402, a wireless communication unit 403, a storage unit 404, and a touch panel 405. The power source circuit 401 to the touch panel 405 are connected to the CPU 400. The power source circuit 401 includes a secondary battery 410.

The CPU 400 is a control device controlling the information processing terminal 102. For example, the CPU 400 reads a program in the present embodiment, and executes the read program. The power source circuit 401 is electrically connected to the CPU 400, and charges the secondary battery 410 in a case of being connected to an AC adaptor. The secondary battery 410 supplies drive power to the touch panel 405 and the like. The flash ROM 402 is electrically connected to the CPU 400, and stores firmware of the information processing terminal 102. The flash ROM 402 stores the program in the present embodiment. The wireless communication unit 403 is electrically connected to the CPU 400, and performs wireless communication with the wearable apparatus 101. The storage unit 404 is electrically connected to the CPU 400, and is a work memory of the CPU 400. For example, the storage unit 404 temporarily stores the program read from the flash ROM 402.

The touch panel 405 is a device in which an operation unit such as a touch sensor is provided on an upper part of a display unit such as a display.

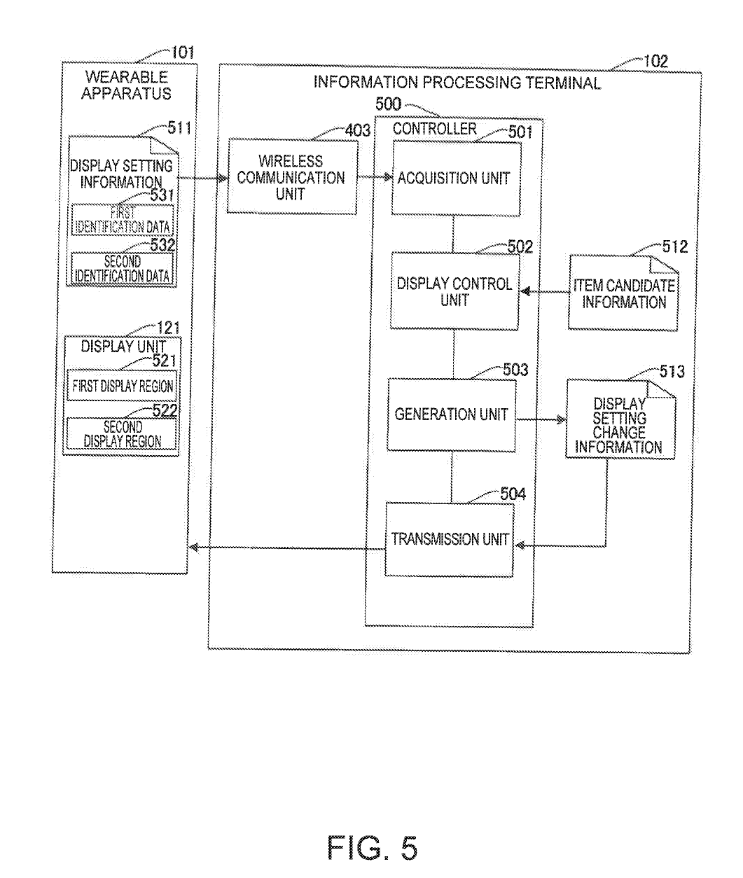

Next, FIG. 5 is a diagram illustrating a functional configuration example of the information processing terminal 102. The information processing terminal 102 includes a controller 500. The controller 500 includes an acquisition unit 501, a display control unit 502, a generation unit 503, and a transmission unit 504. The controller 500 is a function by the CPU 400 executing the program stored in the storage unit 404.

The acquisition unit 501 acquires display setting information 511 from the wearable apparatus 101 via the wireless communication unit 403. The display setting information 511 is information regarding a display screen of the wearable apparatus 101, and has, for example, three aspects. The display setting information 511 in a first aspect is image information indicating a display screen.

The display setting information 511 in a second aspect indicates at least one of the content and a display aspect of a display screen. The display setting information 511 in a third aspect indicates at least one of an order, the content, and a display aspect of a display screen which is switched by the user U performing an operation on the operation buttons 111 to 115 as an operation unit of the wearable apparatus 101. A display aspect of a display screen is, for example, a size, a color, and a font size of text in the display screen, or a size and a background color of the display screen. The acquisition unit 501 stores the acquired display setting information 511 in the storage unit 404 or a storage region of the CPU 400.

The display control unit 502 displays a display setting screen on the touch panel 405 on the basis of the display setting information 511. The touch panel 405 functions as a display unit of the information processing terminal 102. The display setting screen is used to change the content of a display screen. For example, in a case where the display setting information 511 is image information indicating a display screen, the display control unit 502 displays an image indicated by the image information on the touch panel 405. In a case where the display setting information 511 indicates at least one of an order, the content, and a display aspect of a display screen, the display control unit 502 displays an image on the touch panel 405 on the basis of the display setting information 511. Specifically, in a case where the display setting information 511 includes an order of a display screen, the display control unit 502 displays a display setting screen in which an order of a display screen changed by the user U is reflected on the touch panel 405. In a case where the display setting information 511 includes the content of a display screen, the display control unit 502 displays a display setting screen in which the content of a display screen changed by the user U is reflected on the touch panel 405. In a case where the display setting information 511 includes a display aspect of a display screen, the display control unit 502 displays a display setting screen in which a display aspect of a display screen changed by the user U is reflected on the touch panel 405.

Here, changing an order of a display screen includes at least one of replacing orders of display screens displayed in response to operations on the operation buttons 111 to 115, adding any display screen, and deleting any display screen. In other words, changing an order of a display screen indicates changing the number of operations on the operation buttons 111 to 115 for displaying any display screen.

Changing the content of a display screen includes adding information to be displayed to or deleting information displayed from any display screen.

Changing a display aspect of a display screen is to change an expression of an item or information displayed in a display screen, and includes, for example, changing or selecting an expression method of text display including text or numbers, graph display, or icon display.

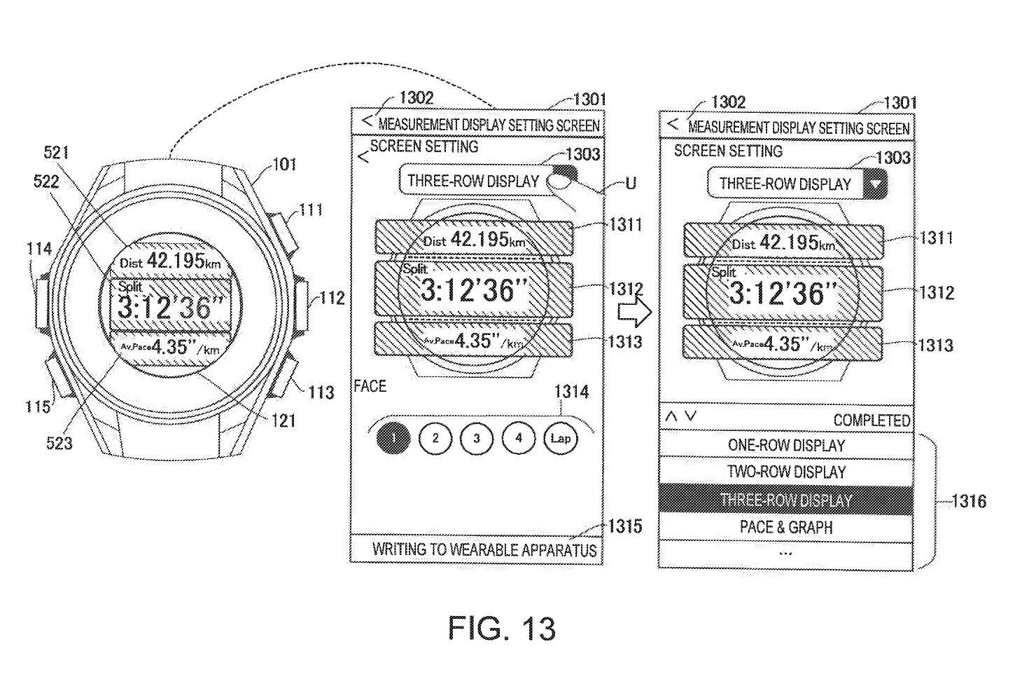

The information processing terminal 102 stores image information correlated with each of pieces of identification information of a plurality of display screens in the storage unit 404 or the like in advance. The display control unit 502 reads image information corresponding to identification information of a display screen included in the display setting information 511 acquired by the acquisition unit 501 from the storage unit 404, and displays an image indicated by the read image information on the touch panel 405. Specific examples of a display setting screen include an activity amount display setting screen illustrated in FIG. 11, a workout display setting screen illustrated in FIG. 12, and a measurement display setting screen illustrated in FIG. 13.

The generation unit 503 generates display setting change information 513 on the basis of the user U's change operation on a display setting screen displayed on the touch panel 405. The display setting change information 513 has, for example, two aspects. The display setting change information 513 in a first aspect has the same information as that of the display setting information 511. The display setting change information 513 in a second aspect has information of only a changed part in the display setting information 511. For example, it is assumed that the display setting information 511 has information regarding two display screens, and only information regarding a second display screen is changed by a change operation performed by the user U. If the display setting change information 513 is in the second aspect, the generation unit 503 generates information regarding the second display screen as the display setting change information 513. The generation unit 503 stores the generated display setting change information 513 in the storage unit 404, a storage region of the CPU 400, or the like.

The transmission unit 504 transmits the display setting change information 513 from the information processing terminal 102 to the wearable apparatus 101. The wearable apparatus 101 displays a display screen by using the display setting change information 513.

As described above, display screens to be displayed on the display unit 121 are sequentially switched in response to the user U's operations on the operation buttons 111 to 115. The display control unit 502 displays a display setting screen in which a plurality of display screens are disposed to be correlated with orders of the user U's operations on the operation buttons 111 to 115 on the display unit 121. For example, it is assumed that a plurality of display screens to be displayed on the display unit 121 are sequentially switched depending on the number of pressing the first operation button 111. In this case, the display control unit 502 disposes the plurality of display screens in an order of the number of pressing the first operation button 111 in the display setting screen.

As described above, the generation unit 503 generates the display setting change information 513 on the basis of the user U's change operation on a display setting screen displayed on the touch panel 405. In a case where a change operation regarding at least one of an order, the content, and a display aspect of a display screen to be displayed on the display unit 121, the generation unit 503 generates the display setting change information 513.

More specifically, the generation unit 503 may generate the display setting change information 513 right after the change operation is received, and may generate the display setting change information 513 in a case where the change operation is received and then the user U's operation is not received for a predetermined time.

In a case where an instruction for transmitting the display setting change information 513 is received from the user U, the generation unit 503 may generate the display setting change information 513 on the basis of a change operation received before the instruction.

The wearable apparatus 101 may measure a plurality of items indicating a state of the user U. The plurality of items include, for example, a heart rate of the user U which can be measured by the pulse sensor 309, GPS positioning, and a movement distance of the user U which can be measured by the acceleration sensor 307. The display unit 121 may include a first display region 521 and a second display region 522. The display unit 121 may include three or more display regions. A screen displayed on the display unit 121 including the first display region 521 and the second display region 522 is illustrated in FIG. 13 or the like.

Next, at least one item selected from among a plurality of items is displayed in the first display region 521, and, similarly, at least one item selected from a plurality of items is displayed in the second display region 522. The display setting information 511 includes first identification data 531 for identifying an item to be displayed in the first display region 521 and second identification data 532 for identifying an item to be displayed in the second display region 522. For example, it is assumed that an item to be displayed in the first display region 521 is a heart rate, and an item to be displayed in the second display region 522 is a distance. In this case, the first identification data 531 is data for identifying the heart rate, and the second identification data 532 is data for identifying the distance.

Next, the display control unit 502 displays an image to be displayed in the first display region 521 on the touch panel 405 on the basis of the first identification data 531, and displays an image to be displayed in the second display region 522 on the touch panel 405 on the basis of the second identification data 532.

The display control unit 502 displays an image based on a plurality of item candidates of items which can be displayed in the first display region 521 in response to an operation on the touch panel 405. Here, as a display method of an image based on a plurality of item candidates, the display control unit 502 performs, for example, either of the following two methods. In a first method, the display control unit 502 refers to item candidate information 512, and displays an image based on a plurality of item candidates. The item candidate information 512 in the first method is information having item candidates of items which can be displayed. In a second method, the item candidate information 512 in the second method has item candidates of items which can be displayed for each workout. The display control unit 502 in the second method refers to the item candidate information 512 in the second method, and displays an image based on item candidates corresponding to the current workout. In the following description, a case where the display control unit 502 performs the second method will be described.

The generation unit 503 updates the first identification data 531. The updated first identification data 531 indicates an item selected from among a plurality of item candidates in response to an operation on the touch panel 405. For example, it is assumed that an item to be displayed in the first display region 521 is updated to an elevation from a heart rate in response to an operation on the touch panel 405. In this case, the generation unit 503 updates the first identification data 531 indicating the heart rate to the first identification data 531 indicating the elevation.

Thereafter, the transmission unit 504 transmits the display setting change information 513 including the updated first identification data 531 to the wearable apparatus 101.

The plurality of item candidates include, for example, at least one of the following three items. A first item is a time point. A second item is an item regarding an activity of the user U, and corresponds to, for example, a heart rate.

A third item is an item regarding an index obtained by analyzing an activity of the user U. The index obtained by analyzing an activity of the user U is a value obtained by applying a predetermined process to a value obtained by the sensor or the like of the wearable apparatus 101. Such an index includes, for example, the number of steps, an average pace, an average stride, an average speed, and a lap. The lap is a movement distance of the wearable apparatus 101 per unit time, the time required for movement of the wearable apparatus 101 per unit distance, or a number of each of a plurality of predefined running sections. The movement distance of the wearable apparatus 101 indicates a movement distance of the user U wearing the wearable apparatus 101. Similarly, the time required for movement of the wearable apparatus 101 indicates the time required for movement of the user U wearing the wearable apparatus 101. Here, the unit time is, for example, one minute or one hour. The unit time may be a time interval designated by the user U. Similarly, the unit distance may be, for example, 1 mile or 1 km. The unit distance may be a distance interval designated by the user U. It is assumed that, with respect to a number of each of a plurality of predefined running sections, a running section every km is predefined as a plurality of running sections. In this case, a number of an initial running section of 1 km is “1”, and a number of the next running section of 1 km is “2”.

It is assumed that the display setting information 511 is information regarding the content of a display screen to be displayed on the display unit 121 according to the user U's operations on the operation buttons 111 to 115. In this case, the display control unit 502 may display a simulation image, and an image indicating the content included in the display setting information 511, on the touch panel 405. Here, the simulation image is an image simulating the wearable apparatus 101 as described with reference to FIG. 1, and has, for example, two display content aspects and two display range aspects. The simulation image in the first display content aspect is a picture image of the wearable apparatus 101 from a direction in which the display unit 121 is viewed. The simulation image in the second display content aspect is an image in which a feature of the wearable apparatus 101 from the direction in which the display unit 121 is viewed is exaggerated, simplified in an emphasis manner, or omitted. The simulation image in the first display range aspect is an image of the entire wearable apparatus 101. The simulation image in the second display range aspect is an image indicating only an outline of the wearable apparatus 101. The simulation image may employ any of combinations of the two display content aspects and the two display range aspects.

In a display method of the simulation image and an image indicating the content included in the display setting information 511, the display control unit 502 performs a method corresponding to each of the two display range aspects of the simulation image. In a case where the first display range aspect is employed, the display control unit 502 displays an image on which the image indicating the content included in the display setting information 511 is superimposed, at a position on the simulation image corresponding to the display unit 121, on the touch panel 405. In a case where the second display range aspect is employed, the display control unit 502 displays the simulation image on the touch panel 405, and also displays the image indicating the content included in the display setting information 511 inside an outline indicated by the simulation image in the touch panel 405.

The display setting information 511 is assumed to be information regarding the content and a display aspect of a display screen to be displayed on the display unit 121 according to the user U's operations on the operation buttons 111 to 115. In this case, the display control unit 502 sets a display aspect of the simulation image by using a display aspect included in the display setting information 511. The display control unit 502 displays an image in which the image indicating the content included in the display setting information 511 is superimposed on the simulation image after being set on the touch panel 405 as a display screen.

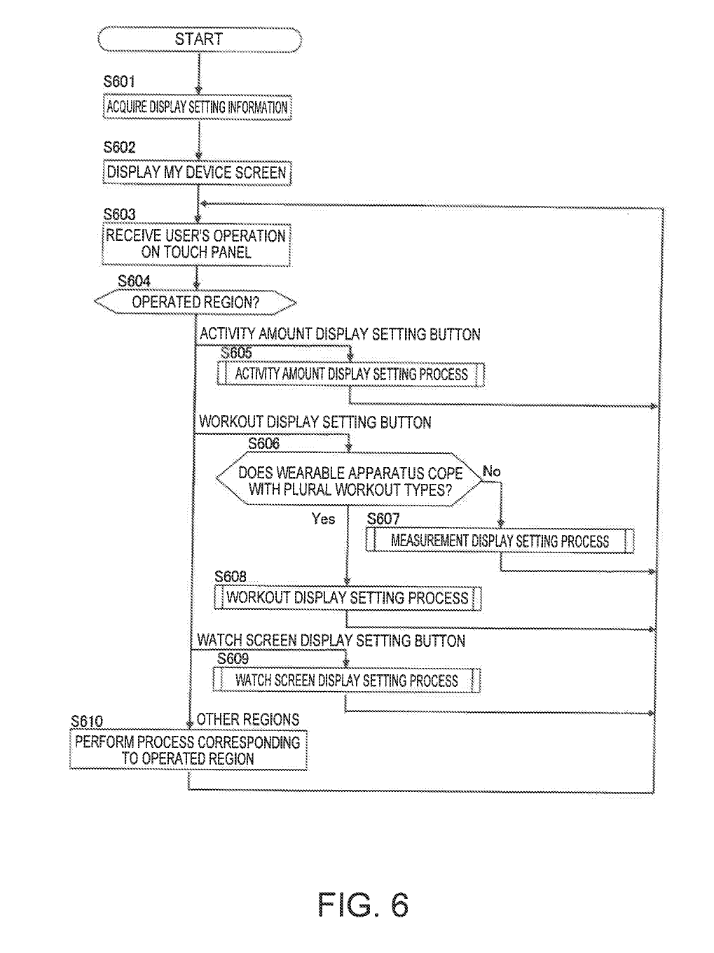

Next, a description will be made of a flowchart illustrating the content of a my device screen display process performed by the information processing terminal 102 with reference to FIGS. 6 to 9.

FIG. 6 is a flowchart illustrating the content of a my device screen display process. First, the CPU 400 acquires the display setting information 511 from the wearable apparatus 101 wirelessly connected via the wireless communication unit 403 (step S601). Next, the CPU 400 displays a my device screen on the touch panel 405 (step S602). Here, the my device screen is a screen for performing setting regarding an operation of the wearable apparatus 101.

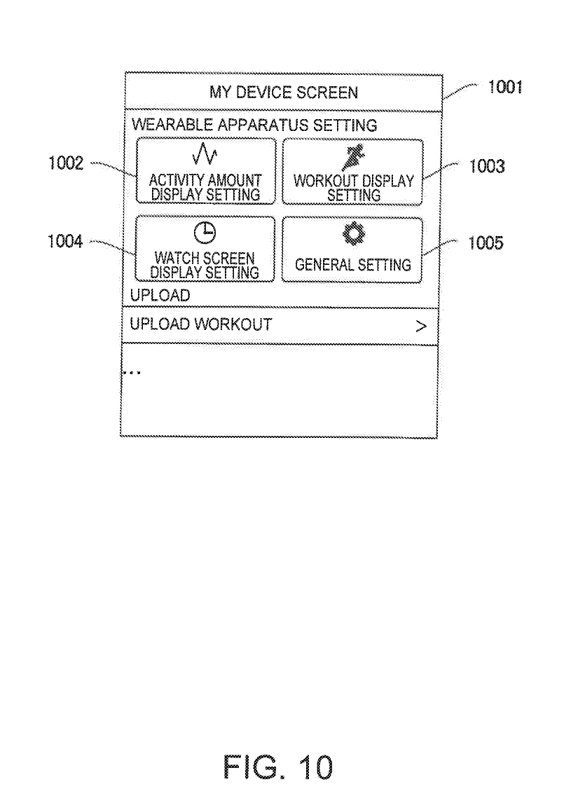

FIG. 10 illustrates a my device screen 1001 displayed through the process in step S602. The my device screen 1001 includes an activity amount display setting button 1002, a workout display setting button 1003, a watch screen display setting button 1004, and a general setting button 1005.

The description returns to FIG. 6. After the process in step S602 is completed, the CPU 400 receives an operation on the touch panel 405 performed by the user U (step S603). In a case where the operation from the user U is received, the CPU 400 determines a region operated by the user U (step S604).

In a case where the operated region is the inside of the activity amount display setting button 1002 (step S604: activity amount display setting button), the CPU 400 performs an activity amount display setting process (step S605). In the activity amount display setting process, an activity amount display screen to be displayed in the wearable apparatus 101 is set. After the process in step S605 is completed, the CPU 400 returns the process to step S603.

In a case where the operated region is the inside of the workout display setting button 1003 (step S604: workout display setting button), the CPU 400 determines whether or not the wearable apparatus 101 connected via the wireless communication unit 403 copes with a plurality of workout types (step S606). For example, the CPU 400 acquires information indicating the type of wearable apparatus 101 from the wearable apparatus 101, and performs the determination.

In a case where the wearable apparatus 101 connected via the wireless communication unit 403 (step S606: No), the CPU 400 performs a measurement display setting process (step S607). The measurement display setting process is a process of setting an aspect of displaying a measurement result in a predetermined workout. On the other hand, in a case where the wearable apparatus 101 connected via the wireless communication unit 403 (step S606: Yes), the CPU 400 performs a workout display setting process (step S608). In the workout display setting process, a workout display screen to be displayed in the wearable apparatus 101 is set. After process in step S606 or step S607 is completed, the CPU 400 returns the process to step S603.

In a case where the operated region is the inside of the watch screen display setting button 1004 (step S604: watch screen display setting button), the CPU 400 performs a watch screen display setting process (step S609). In the watch screen display setting process, the content to be displayed in a watch screen is set. After the process in step S609 is completed, the CPU 400 returns the process to step S603.

In a case where the operated region is a region other than the activity amount display setting button 1002, the workout display setting button 1003, and the watch screen display setting button 1004 (step S604: others), the CPU 400 performs a process corresponding to the operated region (step S610). Here, the other region is, for example, the general setting button 1005. In a case where the operated region is the general setting button 1005, the CPU 400 performs a general setting process. In the general setting process, for example, an upper limit and a lower limit of each heart rate zone are set, ON and OFF of a summer time are set, or whether or not a time zone is made automatic is set. After the process in step S610 is completed, the CPU 400 returns the process to step S603.

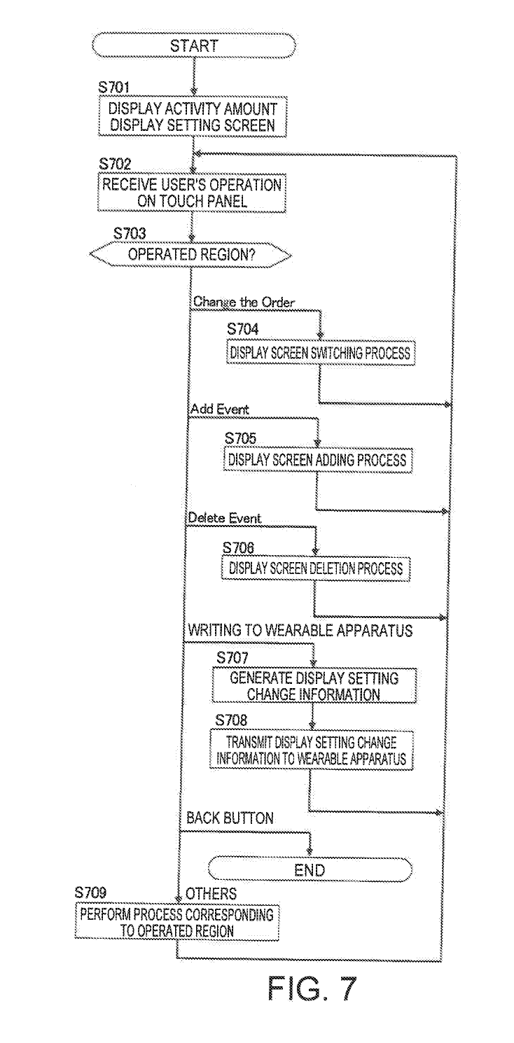

FIG. 7 is a flowchart illustrating the content of an activity amount display setting process. The CPU 400 displays an activity amount display setting screen on the touch panel 405 (step S701). The activity amount display setting screen is a screen in which respective activity amount display simulation screens simulating a plurality of activity amount display screens displayed by the wearable apparatus 101 are displayed to be arranged in an order of the number of pressing operations on the first operation button 111.

FIG. 11 illustrates an activity amount display setting screen 1101 displayed through the process in step S701. The activity amount display setting screen 1101 illustrated on the left part in FIG. 11 indicates a state before a menu display button 1103 is pressed, and the activity amount display setting screen 1101 illustrated on the right part in FIG. 11 indicates a state after the menu display button 1103 is pressed. The activity amount display setting screen 1101 illustrated on the left part in FIG. 11 includes a back button 1102, the menu display button 1103, a watch simulation screen 1111, and respective activity amount display simulation screens 1112 to 1114. The watch simulation screen 1111 is a screen simulating the watch screen 200 illustrated in FIG. 2. The activity amount display setting screen 1101 illustrated on the right part in FIG. 11 includes a menu item 1121 indicating Change the Order, a menu item 1122 indicating Add Event, and a menu item 1123 indicating Delete Event.

The activity amount display setting screens 1101 illustrated in FIG. 11 do not include a region indicating writing to the wearable apparatus 101, but may include a region indicating writing to the wearable apparatus 101 under the activity amount display setting screen 1101, for example. In a case where an order of displaying an activity amount display screen is changed according to any one of the menu items 1121 to 1123, the CPU 400 may display a region indicating writing to the wearable apparatus 101 in the activity amount display setting screen 1101.

Each of the activity amount display simulation screens 1112 to 1114 and the watch simulation screen 1111 illustrated in FIG. 11 include a simulation image of the wearable apparatus 101. For example, the activity amount display simulation screen 1112 is a screen simulating an activity amount display screen for “Summary2”. The activity amount display simulation screen 1113 is a screen simulating an activity amount display screen for “Heart Rate”. The activity amount display simulation screen 1114 is a screen simulating an activity amount display screen for “Summary1”.

In a case where the entire activity amount display setting screen 1101 cannot be displayed on the touch panel 405, the CPU 400 may display some regions of the activity amount display setting screen 1101 on the touch panel 405. The CPU 400 may change a region in which the activity amount display setting screen 1101 is displayed through a swipe operation.

The activity amount display setting screen 1101 indicates that the activity amount display screen for “Summary2” is displayed on the display unit 121 if the user U presses the first operation button 111 when a watch screen is displayed on the display unit 121. The activity amount display setting screen 1101 indicates that the activity amount display screen for “Heart Rate”, the activity amount display screen for “Summary1”, and the watch screen 200 are displayed in an order of pressing the first operation button 111.

The simulation image of the wearable apparatus 101 in each of the activity amount display simulation screens 1112 to 1114 is an image stored in the information processing terminal 102 in advance as described with reference to FIG. 5. The numerical values in the activity amount display simulation screens 1112 to 1114 are only examples, and are not values obtained by measuring activity of the user U or index values obtained by analyzing measured values. However, the CPU 400 may acquire values obtained by measuring activity of the user U or index values obtained by analyzing measured values from the wearable apparatus 101, and may display the values or the index values as numerical values in the activity amount display simulation screens 1112 to 1114. In a state in which the wearable apparatus 101 and the information processing terminal 102 perform communication with each other, the CPU 400 may acquire values measured in the wearable apparatus 101 in real time by the information processing terminal 102, and may display the values in the activity amount display simulation screens 1112 to 1114.

The description returns to FIG. 7.

After the process in step S701 is completed, the CPU 400 receives an operation on the touch panel 405 performed by the user U (step S702). In a case where the operation from the user U is received, the CPU 400 determines a region operated by the user U (step S703).

In a case where the operated region is the inside of the menu item 1121 indicating Change the Order (step S703: Change the Order), the CPU 400 performs a display screen switching process (step S704). In the display screen switching process, for example, the CPU 400 displays a button for one-step upward movement and a button for one-step downward movement in each activity amount display simulation screen. In a case where the button for one-step upward movement is pressed, the CPU 400 replaces an activity amount display simulation screen corresponding to the button for one-step upward movement with an activity amount display simulation screen above the activity amount display screen corresponding to the button for one-step upward movement. After the process in step S704 is completed, the CPU 400 returns the process to step S702.

In a case where the operated region is the inside of the menu item 1122 indicating Add Event (step S703: Add Event), the CPU 400 performs a display screen adding process (step S705). As the display screen adding process, for example, the CPU 400 displays an icon indicating a new activity amount display simulation screen to be added. The user U moves the displayed icon through a swipe operation. The CPU 400 disposes the new activity amount display simulation screen between the currently displayed activity amount display simulation screens according to a position where the user U releases the finger from the icon. After the process in step S705 is completed, the CPU 400 returns the process to step S702.

In a case where the operated region is the inside of the menu item 1123 indicating Delete Event (step S703: Delete Event), the CPU 400 performs a display screen deletion process (step S706). In the display screen deletion process, for example, the CPU 400 displays a delete button in each of the respective activity amount display simulation screens. The CPU 400 deletes an activity amount display simulation screen corresponding to a pressed button. After the process in step S706 is completed, the CPU 400 returns the process to step S702.

Through the processes in steps S704 to S706, the user U can perform operations such as replacement of orders of a plurality of activity amount display screen, and adding or deletion of an activity amount display screen while checking the plurality of activity amount display screens in a single screen such as the activity amount display setting screen 1101. Here, orders of arranging the plurality of activity amount display screens in the activity amount display setting screen 1101 correspond to the number of operating the first operation button 111. Thus, the user U can intuitively perform replacement of orders of a plurality of activity amount display screen, and adding or deletion of an activity amount display screen.

In a case where the operated region is a region indicating writing to the wearable apparatus 101 (step S703: writing to wearable apparatus 101), the CPU 400 generates the display setting change information 513 on the basis of the user U's change operation on the activity amount display setting screen (step S707). The CPU 400 transmits the generated display setting change information 513 to the wearable apparatus 101 connected via the wireless communication unit 403 (step S708). After the process in step S708 is completed, the CPU 400 returns the process to step S702.

In a case where the operated region is the inside of the back button 1102 (step S703: back button), the CPU 400 finishes the activity amount display setting process. The activity amount display setting process is finished, and thus the CPU 400 returns to the my device screen display process. In this case, the CPU 400 displays the previous screen, that is, the my device screen 1001 again, and performs the process in step S603.

In a case where the operated region is the other region (step S703: others), the CPU 400 performs a process corresponding to the operated region (step S709). Here, the other region is a region other than the menu items 1121 to 1123, the region indicating writing to the wearable apparatus 101, and the back button 1102. After the process in step S709 is completed, the CPU 400 returns the process to the process in step S702.

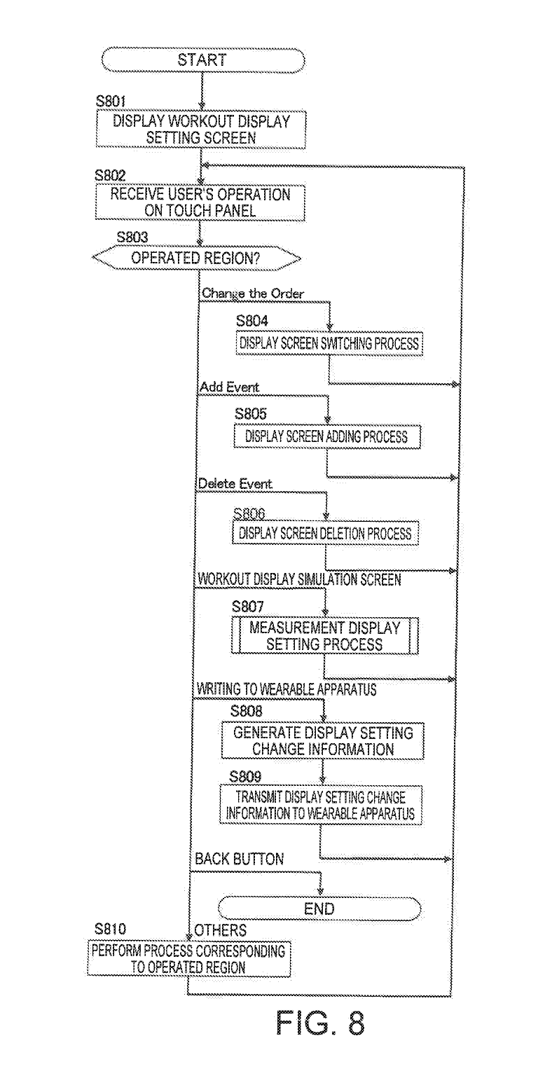

FIG. 8 is a flowchart illustrating the content of the workout display setting process. The CPU 400 displays a workout display setting screen on the touch panel 405 (step S801). The workout display setting screen is a screen in which respective workout display simulation screens simulating a plurality of workout display screens to be displayed by the wearable apparatus 101 are arranged in an order of the number of pressing operations on the first operation button 111. A specific example of the workout display setting screen is illustrated in FIG. 12.

FIG. 12 illustrates a workout display setting screen 1201 displayed through the process in step S801. The workout display setting screen 1201 illustrated on the left part in FIG. 12 indicates a state before the menu display button 1103 is pressed, and the workout display setting screen 1201 illustrated on the right part in FIG. 12 indicates a state after the menu display button 1103 is pressed. The workout display setting screen 1201 illustrated on the left part in FIG. 12 includes the back button 1102, the menu display button 1103, the watch simulation screen 1111, and respective workout display simulation screens 1202 to 1204. The workout display setting screen 1201 illustrated on the right part in FIG. 12 includes the menu item 1121 indicating Change the Order, the menu item 1122 indicating Add Event, and the menu item 1123 indicating Delete Event.

The workout display setting screens 1201 illustrated in FIG. 12 do not include a region indicating writing to the wearable apparatus 101, but may include a region indicating writing to the wearable apparatus 101 under the workout display setting screen 1201, for example. In a case where an order of displaying a workout display screen is changed according to any one of the menu items 1121 to 1123, the CPU 400 may display a region indicating writing to the wearable apparatus 101 in the workout display setting screen 1201.

Here, with reference to items in the workout display setting screen 1201 illustrated in FIG. 12, an item having the same reference numeral as that in the activity amount display setting screen 1101 functions in the same manner as that in the activity amount display setting screen 1101, and thus description thereof will be omitted. A workout display simulation screen 1202 is a screen simulating a screen displaying a “run” as a workout type. A workout display simulation screen 1203 is a screen simulating a screen displaying “biking” as a workout type. A workout display simulation screen 1204 is a screen simulating a screen displaying a “triathlon” as a workout type.

The workout display setting screen 1201 illustrated in FIG. 12 indicates that a workout display screen for the run item is displayed on the display unit 121 if the user U presses the third operation button 113 when a watch screen is displayed on the display unit 121. The workout display setting screen 1201 indicates that the workout display screen for the biking item, the workout display screen for the triathlon item, and the watch screen are displayed in an order of pressing the third operation button 113.

The description returns to FIG. 8.

After the process in step S801 is completed, the CPU 400 receives an operation on the touch panel 405 performed by the user U (step S802). In a case where the operation from the user U is received, the CPU 400 determines a region operated by the user U (step S803).

In a case where the operated region is the inside of the menu item 1121 indicating Change the Order (step S803: Change the Order), the CPU 400 performs a display screen switching process (step S804). The display screen switching process in the workout display setting process is the same as the display screen switching process in the activity amount display setting process, and thus description thereof will be omitted. After the process in step S804 is completed, the CPU 400 returns the process to step S802.

In a case where the operated region is the inside of the menu item 1122 indicating Add Event (step S803: Add Event), the CPU 400 performs a display screen adding process (step S805). The display screen adding process in the workout display setting process is the same as the display screen adding process in the activity amount display setting process, and thus description thereof will be omitted. After the process in step S805 is completed, the CPU 400 returns the process to step S802.

In a case where the operated region is the inside of the menu item 1123 indicating Delete Event (step S803: Delete Event), the CPU 400 performs a display screen deletion process (step S806). The display screen deletion process in the workout display setting process is the same as the display screen deletion process in the activity amount display setting process, and thus description thereof will be omitted. After the process in step S806 is completed, the CPU 400 returns the process to step S802.

Through the processes in steps S804 to S806, the user U can perform operations such as replacement of orders of a plurality of workout display screens, and adding or deletion of a workout display screens while checking the plurality of workout display screens in a single screen such as the workout display setting screen 1201. Here, orders of arranging the plurality of workout display screens in the workout display setting screen 1201 correspond to the number of operating the third operation button 113. Thus, the user U can intuitively perform replacement of orders of a plurality of workout display screens, and adding or deletion of a workout display screen.

In a case where the operated region is the inside of any of the workout display simulation screens 1202 to 1204 (step S803: workout display simulation screen), the CPU 400 performs a measurement display setting process (step S807). After the process in step S807 is completed, the CPU 400 returns the process to the process in step S802.

In a case where the operated region is a region indicating writing to the wearable apparatus 101 (step S803: writing to wearable apparatus 101), the CPU 400 generates the display setting change information 513 on the basis of the user U's change operation on the workout display setting screen (step S808). The CPU 400 transmits the generated display setting change information 513 to the wearable apparatus 101 connected via the wireless communication unit 403 (step S809). After the process in step S809 is completed, the CPU 400 returns the process to step S802.

In a case where the operated region is the inside of the back button 1102 (step S803: back button), the CPU 400 finishes the workout display setting process. The workout display setting process is finished, and thus the CPU 400 returns to the previous screen, that is, the my device screen display process. In this case, the CPU 400 displays the my device screen 1001 again, and performs the process in step S603.

In a case where the operated region is the other region (step S803: others), the CPU 400 performs a process corresponding to the operated region (step S810). Here, the other region is a region other than the menu items 1121 to 1123, the workout display simulation screens 1202 to 1204, the region indicating writing to the wearable apparatus 101, and the back button 1102. After the process in step S810 is completed, the CPU 400 returns the process to the process in step S802.

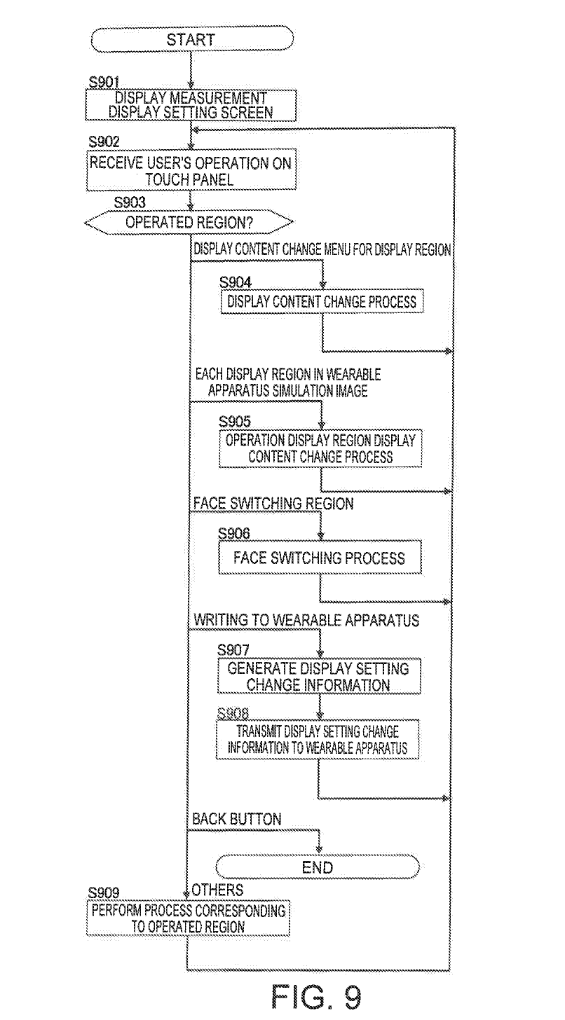

FIG. 9 is a flowchart illustrating the content of the measurement display setting process. The CPU 400 displays a measurement display setting screen (step S901). The measurement display setting screen is a screen for setting the type of value measured by each sensor of the wearable apparatus 101. A specific example of the measurement display setting screen is illustrated in FIG. 13.

FIG. 13 illustrates a measurement display setting screen 1301 displayed through the process in step S901. The measurement display setting screen 1301 at the center in FIG. 13 includes a back button 1302, a display content change menu 1303 for a display region, respective display regions 1311 to 1313 in a wearable apparatus simulation image, a face switching region 1314, and a region 1315 indicating writing to the wearable apparatus 101.

Here, the display region 1311 illustrated in FIG. 13 corresponds to the first display region 521 of the wearable apparatus 101, the display region 1312 corresponds to the second display region 522, and the display region 1313 corresponds to a third display region 523. Among buttons for respective faces in the face switching region 1314 illustrated in FIG. 13 and the subsequent figures, a button for a currently selected face is illustrated by an outline character. The face is a dial plate of the wearable apparatus 101. The user U may set a display screen of the wearable apparatus 101 for each face.

In FIG. 13, it is assumed that the user U presses the display content change menu 1303. In this case, the CPU 400 displays item candidates 1316 which are candidates of selection items of the display content change menu 1303 as illustrated in the measurement display setting screen 1301 on the right part in FIG. 13.

The description returns to FIG. 9.

After the process in step S901 is completed, the CPU 400 receives an operation on the touch panel 405 performed by the user U (step S902). In a case where the operation from the user U is received, the CPU 400 determines a region operated by the user U (step S903).

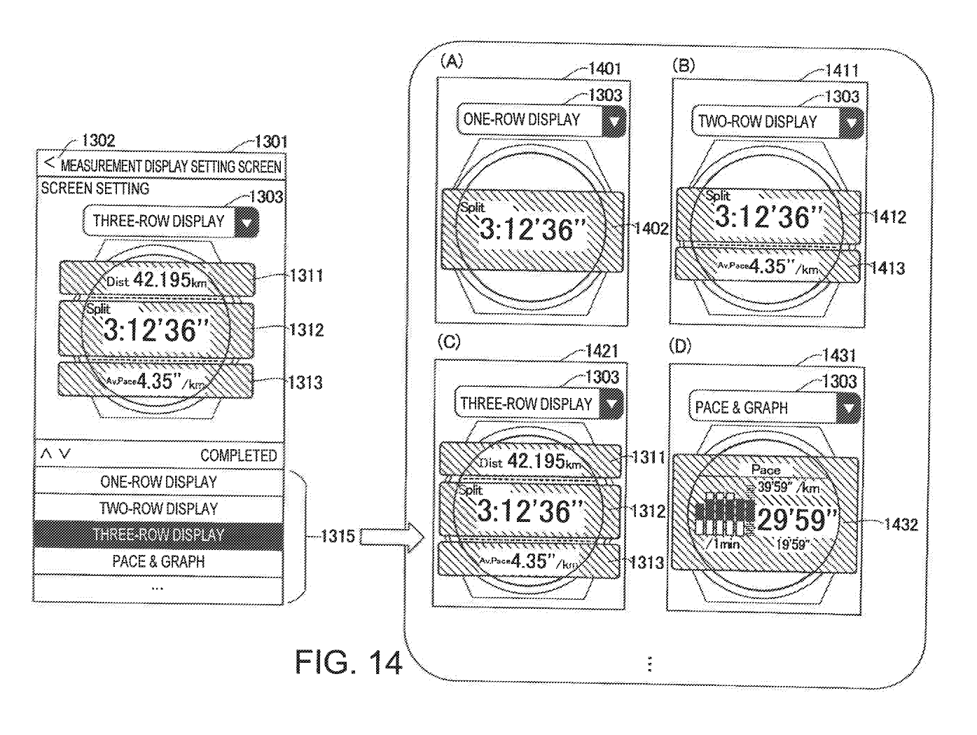

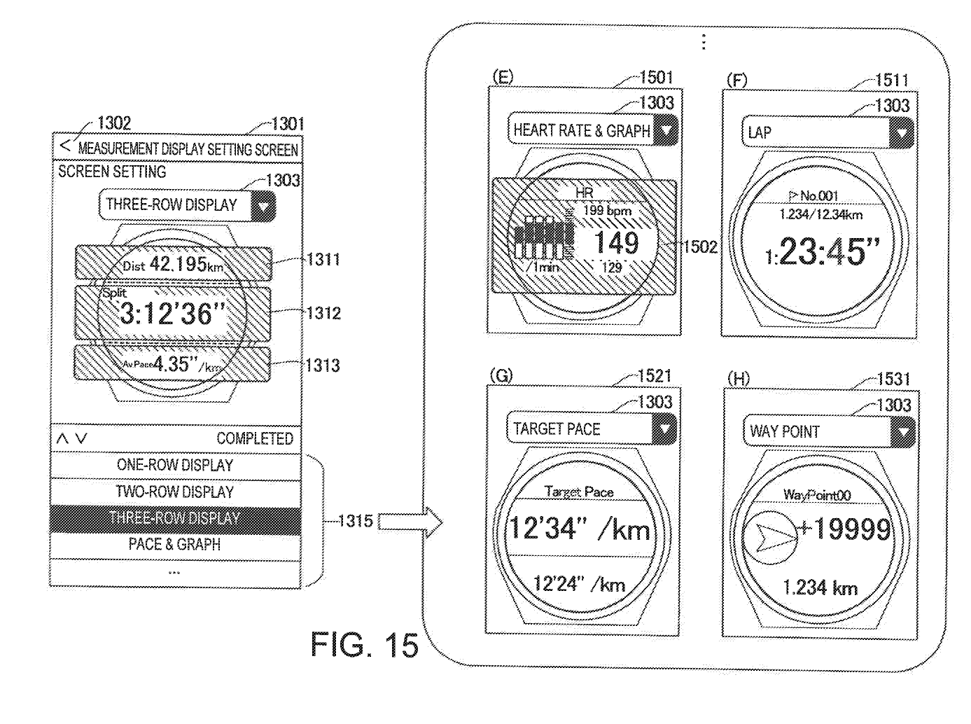

In a case where the operated region is the inside of the display content change menu 1303 for a display region (step S903: display content change menu for display region), the CPU 400 performs a display content change process (step S904). In the display content change process, among the items shown in the display content change menu 1303, the display content in the simulation image of the wearable apparatus 101 is changed to an item designated by the user U. Here, the items shown in the display content change menu 1303 are one-row display, two-row display, three-row display, pace & graph, heart rate & graph, lap, target pace, and way point. A specific example of a measurement display setting screen after change to any of the respective items shown in the display content change menu 1303 is illustrated in FIGS. 14 and 15.

FIGS. 14 and 15 illustrates an example of changing a selection item of the display content change menu. In FIGS. 14 and 15, due to a size of the drawing, only a display region changed in the measurement display setting screen 1301 is displayed.

A display region 1401 illustrated in (A) of FIG. 14 indicates a state in which the selection item of the display content change menu 1303 is changed to “one-row display” by the user U. The CPU 400 displays a display region 1402 of one row according to the changed item. A display region 1411 illustrated in (B) of FIG. 14 indicates a state in which the selection item of the display content change menu 1303 is changed to “two-row display” by the user U. The CPU 400 displays display regions 1412 and 1413 of two rows according to the changed item.

A display region 1421 illustrated in (C) of FIG. 14 indicates a state in which the selection item of the display content change menu 1303 is changed to “three-row display” by the user U. In this case, the selection items are not changed before and after the change, and thus the image in the measurement display setting screen 1301 is not changed. A display region 1431 illustrated in (D) of FIG. 14 indicates a state in which the selection item of the display content change menu 1303 is changed to “pace & graph” by the user U. The CPU 400 displays a display region 1432 in which a value of a pace and a graph indicating the pace are displayed according to the changed item.

A display region 1501 illustrated in (E) of FIG. 15 indicates a state in which the selection item of the display content change menu 1303 is changed to “heart rate & graph” by the user U. The CPU 400 displays a display region 1502 in which a value of a heart rate and a graph indicating the heart rate are displayed according to the changed item. A display region 1511 illustrated in (F) of FIG. 15 indicates a state in which the selection item of the display content change menu 1303 is changed to “lap” by the user U. The CPU 400 displays a lap according to the changed item.

A display region 1521 illustrated in (G) of FIG. 15 indicates a state in which the selection item of the display content change menu 1303 is changed to “target pace” by the user U. The CPU 400 displays a target pace according to the changed item. A display region 1531 illustrated in (H) of FIG. 15 indicates a state in which the selection item of the display content change menu 1303 is changed to “way point” by the user U. The CPU 400 displays a way point according to the changed item.

The description returns to FIG. 9.

After the process in step S904 is completed, the CPU 400 returns the process to step S902.

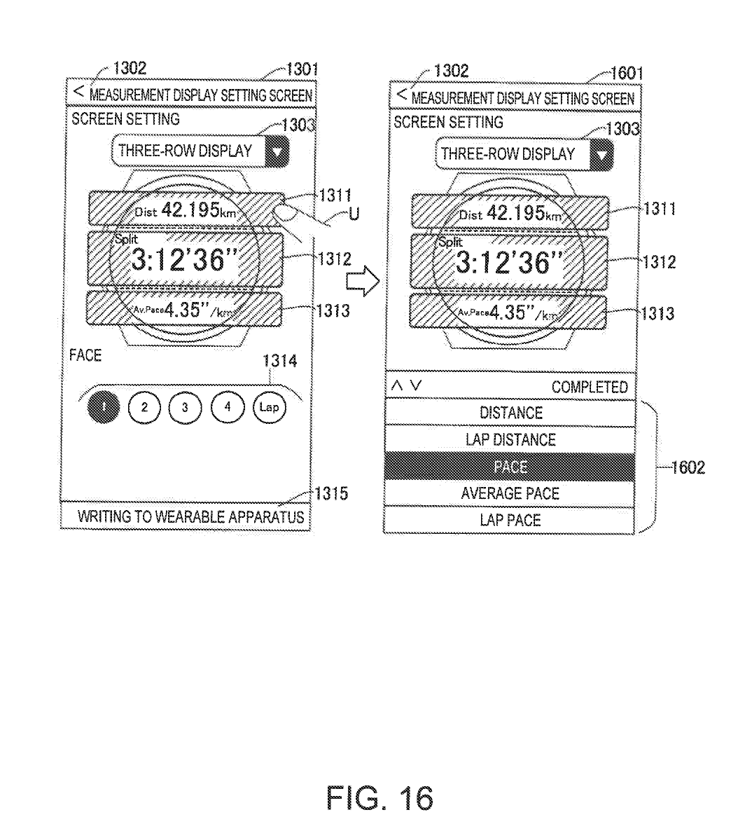

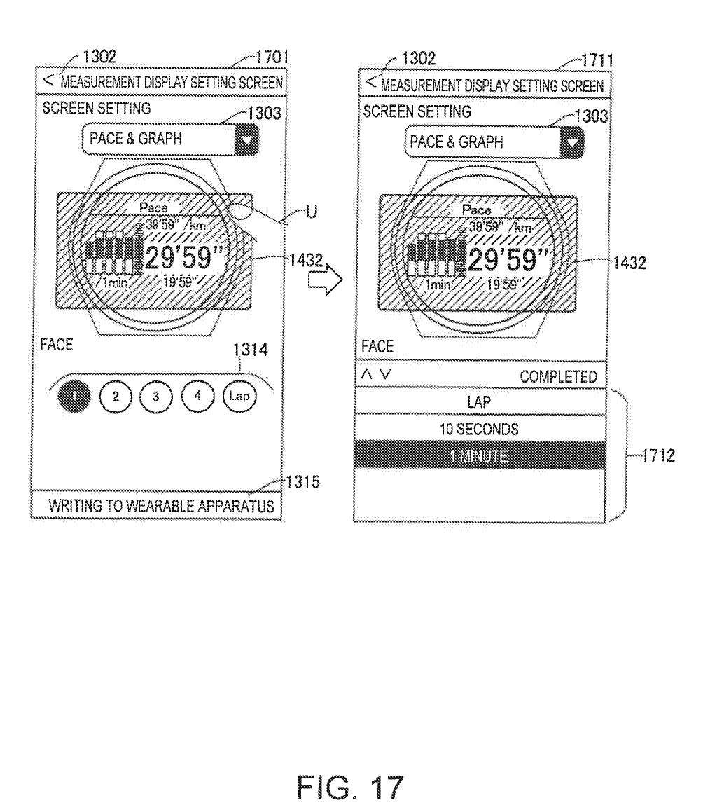

In a case where the operated region is any of the respective display regions 1311 to 1313 in the wearable apparatus simulation image (step S903: each display region in wearable apparatus simulation image), the CPU 400 performs a display region display content change process (step S905). In the display region display content change process, for example, the CPU 400 refers to the item candidate information 512, and displays candidates of items which can be displayed in the current workout type. The CPU 400 displays an item corresponding to an item pressed by the user U among the displayed candidates. A specific example of a measurement display setting screen after the display region display content change process is illustrated in FIGS. 16 and 17.

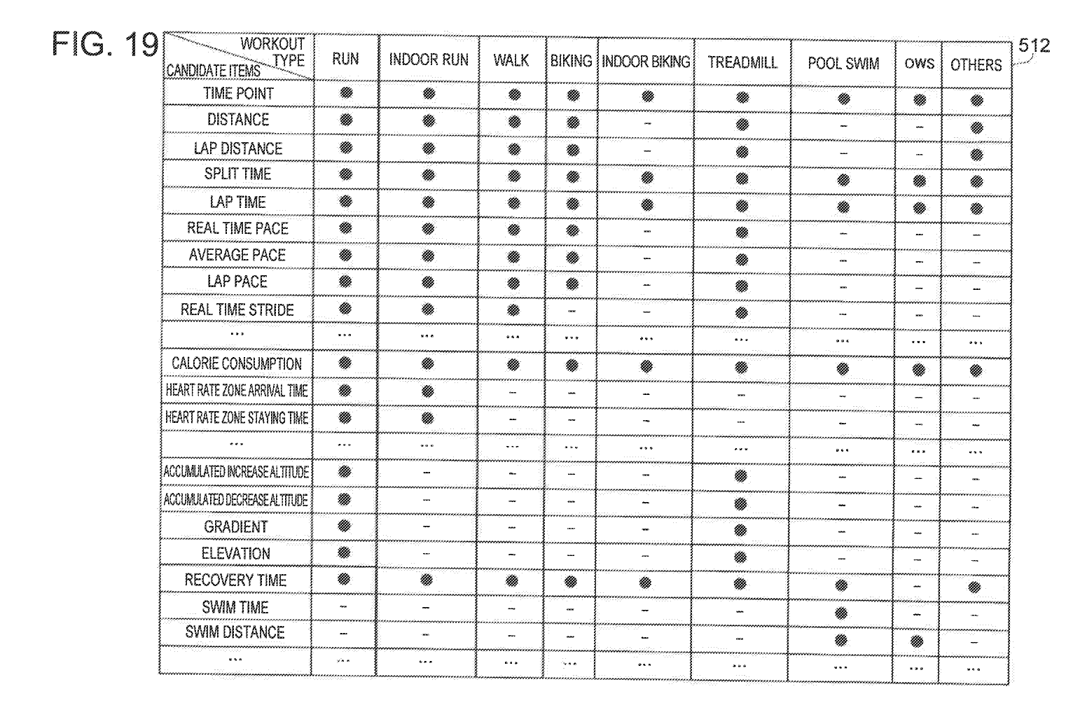

As indicated by the measurement display setting screen 1301 illustrated on the left part in FIG. 16, in a case where the user U presses the display region 1311, the CPU 400 displays a measurement display setting screen 1601 illustrated on the right part in FIG. 16. The measurement display setting screen 1601 includes item candidates 1602 which are candidates of the display region 1311. Here, the displayed item candidates 1602 is item candidates corresponding to the current workout type. Examples of item candidates corresponding to a workout type are illustrated in FIG. 19.

FIG. 19 illustrates item candidates corresponding to a workout. The item candidate information 512 illustrated in FIG. 19 indicates examples of item candidates corresponding to each workout type. “•” in the item candidate information 512 illustrated in FIG. 19 indicates an item candidate corresponding to a workout type, and “-” indicates an item candidate which does not correspond to a workout type. For example, in the run item, a time point, a distance, and the like are item candidates, and a swim time and a swim distance are not item candidates.

A measurement display setting screen 1701 illustrated on the left part in FIG. 17 is a screen including the display region 1432 illustrated in (D) of FIG. 14. As indicated by the measurement display setting screen 1701, in a case where the user U presses the display region 1432, the CPU 400 displays a measurement display setting screen 1711 illustrated on the right part in FIG. 17. The measurement display setting screen 1711 includes item candidates 1712 which can be set as a unit time in a pace.

The description returns to FIG. 9.

After the process in step S905 is completed, the CPU 400 returns the process to step S902.

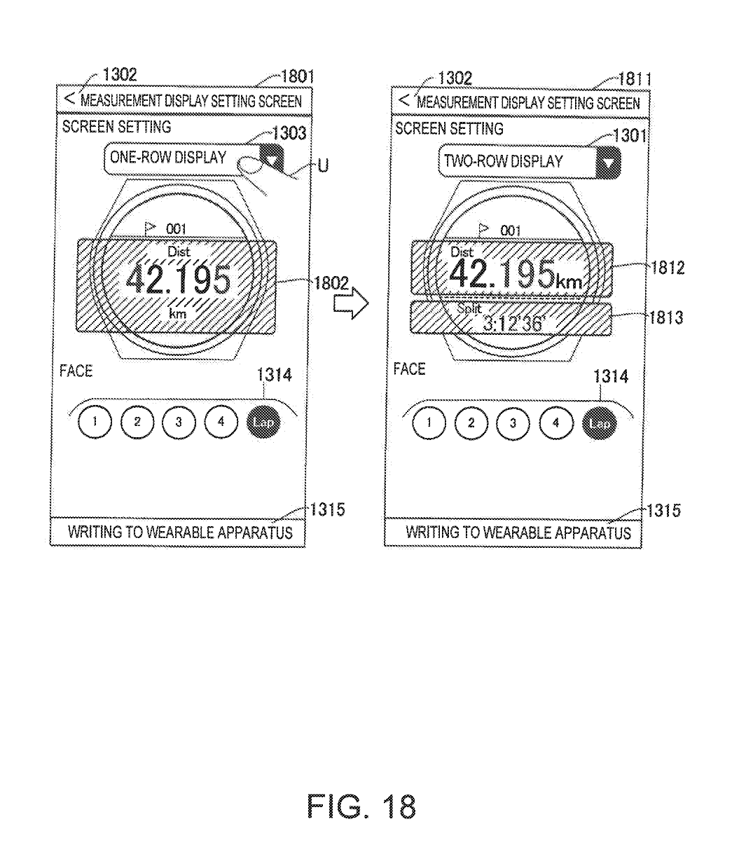

In a case where the operated region is the face switching region 1314 (step S903: face switching region), the CPU 400 performs a face switching process (step S906). In the face switching process, the currently displayed face is switched to a face corresponding to a pressed button, and the display content change menu 1303 and the display regions 1311 to 1313 corresponding to the face after being switched are displayed. A specific example of the measurement display setting screen 1301 after the face is switched is illustrated in FIG. 18.

FIG. 18 illustrates a specific example of a display region when a face is switched. A measurement display setting screen 1801 illustrated on the left part in FIG. 18 indicates a state after the “Lap” button in the face switching region 1314 in the measurement display setting screen 1301 illustrated in FIG. 13 is pressed by the user U. The measurement display setting screen 1801 includes a display region 1802 indicating a lap distance. As indicated by the measurement display setting screen 1801, in a case where the user U presses the display content change menu 1303, and thus “two-row display” is selected from among the item candidates, the CPU 400 displays a measurement display setting screen 1811 illustrated on the right part in FIG. 18. The measurement display setting screen 1811 includes display regions 1812 and 1813 of two rows according to the changed item.

The description returns to FIG. 9.

After the process in step S906 is completed, the CPU 400 returns the process to step S902.

In a case where the operated region is the region 1315 indicating writing to the wearable apparatus 101 (step S903: writing to the wearable apparatus 101), the CPU 400 generates the display setting change information 513 on the basis of the user U's change operation on the measurement display setting screen (step S907). The CPU 400 transmits the generated display setting change information 513 to the wearable apparatus 101 connected via the wireless communication unit 403 (step S908). After the process in step S908 is completed, the CPU 400 returns the process to step S902.

In a case where the operated region is the inside of the back button 1302 (step S903: back button), the CPU 400 finishes the measurement display setting process. The measurement display setting process is finished, and thus the CPU 400 returns to a process which is a call source of the measurement display setting process. The process which is a call source is the my device screen display process or the workout display setting process. In this case, the CPU 400 displays again the previous screen, that is, the my device screen 1001 or the workout display setting screen 1201 on the touch panel 405.

In a case where the operated region is the other region (step S903: others), the CPU 400 performs a process corresponding to the operated region (step S909). Here, the other region is a region other than the region in which the display content change menu 1303 is drawn, the display regions 1311 to 1313, the face switching region 1314, the region 1315 indicating writing to the wearable apparatus 101, and the back button 1302 for return to the previous screen. After the process in step S909 is completed, the CPU 400 returns the process to the process in step S902.

In a watch screen display setting process, the CPU 400 displays a watching setting screen. The watching setting screen is a screen for setting a watch screen of the wearable apparatus 101. The watching setting screen includes respective display regions in a wearable apparatus simulation image, a face switching region, a region indicating writing to the wearable apparatus 101, and a back button for return to the previous screen. A process in a case where each region is operated is the same as each process in the measurement display setting process, and thus description thereof will be omitted.

As described above, the information processing terminal 102 displays the display setting information 511 acquired from the wearable apparatus 101 on the touch panel 405. Therefore, the information processing terminal 102 can display a display setting screen in which a display screen changed by the user U is reflected on the touch panel 405. Consequently, the user U can check the display screen changed by the user U by viewing the touch panel 405.

The information processing terminal 102 transmits the display setting change information 513 generated on the basis of an operation of the user U, to the wearable apparatus 101. Here, in a case where the wearable apparatus 101 has many setting items, if target setting is to be performed by using only the wearable apparatus 101, the user U performs many operations on the operation buttons 111 to 115 or complex operations on combinations of the operation buttons 111 to 115. Therefore, the user U's convenience deteriorates. In contrast, since the information processing terminal 102 enables an operation of a high degree of freedom to be performed or has a large-scale screen compared with the wearable apparatus 101, changing of a display setting screen based on the display setting information 511 can be performed through a simple operation.

Here, regarding a simple operation, for example, in order to select an item, vertical and horizontal buttons are required to be provided in the wearable apparatus 101, but, in the information processing terminal 102, an item can be selected through a simple operation such as touch on the touch panel 405.

In a case where there is a single display screen, the display setting information 511 is preferably information regarding at least one of the content and a display aspect of a display screen. In a case where there are a plurality of display screens, the display setting information 511 is preferably at least one of an order, the content, and a display aspect of a display screen which is switched by the user U performing an operation on the operation buttons 111 to 115. Consequently, the information processing terminal 102 can display a display setting screen which corresponds to information included in the display setting information 511 and is close to an UI provided by the wearable apparatus 101. For example, in a case where the display setting information 511 includes an order of a display screen, the information processing terminal 102 can display a display setting screen in which an order of a display screen changed by the user U is reflected on the touch panel 405. As mentioned above, the display setting screen close to a UI provided by the wearable apparatus 101 is displayed, and thus the user U can perform setting of the wearable apparatus 101 while imagining a use state of the wearable apparatus 101.

A plurality of display screens to be displayed on the display unit 121 according to the user U's operations on the operation buttons 111 to 115 are preferably disposed in the display setting screen in correlation with orders of the operations performed by the user U. As mentioned above, the information processing terminal 102 displays a plurality of display screens to be disposed in correlation with orders of operations performed by the user U. Therefore, a plurality of display screen and orders of operations performed by the user U can be checked by the user U in a single screen, and can thus be presented to the user U to be easily understood.

In a case where a change operation on at least one of an order, the content, and a display aspect of a display screen to be displayed on the display unit 121 is received, the information processing terminal 102 preferably generates the display setting change information 513. Consequently, since the display setting change information 513 is generated when the change operation is received, the information processing terminal 102 can transmit the display setting change information 513 to the wearable apparatus 101 faster than in a case where the display setting change information 513 is generated when a region indicating writing to the wearable apparatus 101 is pressed. Alternatively, the information processing terminal 102 may generate the display setting change information 513 when a region indicating writing to the wearable apparatus 101 is pressed. Consequently, the information processing terminal 102 can reduce the number of generating the display setting change information 513 more than in a case where the display setting change information 513 is generated when a change operation is received. The information processing terminal 102 may switch between generating the display setting change information 513 when a change operation is received and generating the display setting change information 513 when a region indicating writing to the wearable apparatus 101 is pressed, depending on a charge amount of the secondary battery 410. Consequently, the information processing terminal 102 can transmit the display setting change information 513 to the wearable apparatus 101 faster in a case where a charge amount is sufficient, and can save power by reducing the number of generating the display setting change information 513 in a case where a charge amount is small.

With respect to a plurality of items indicating a state of the user U, the information processing terminal 102 preferably transmits the display setting change information 513 including identification data of an updated item to the wearable apparatus 101. Consequently, the wearable apparatus 101 can display an item desired by the user U among a plurality of items in the first display region 521. For example, it is assumed that the user U desires a heart rate to be displayed in the wearable apparatus 101. In this case, the information processing terminal 102 transmits the display setting change information 513 including data for identifying the heart rate to the wearable apparatus 101, and thus the wearable apparatus 101 can display the heart rate in the first display region 521.

The item candidates 1602 preferably include at least one of an item regarding activity of the user U or an item regarding an index obtained by analyzing the activity of the user U. For example, it is assumed that the user U desires the number of steps to be displayed as an item regarding an index obtained by analyzing activity of the user U. In this case, the information processing terminal 102 transmits the display setting change information 513 including data for identifying the number of steps to the wearable apparatus 101, and thus the wearable apparatus 101 can display the number of steps in the first display region 521.

The item candidates 1602 preferably include a time point. Here, as described in FIG. 1, the wearable apparatus 101 has the same appearance as that of a wristwatch. It is assumed that the user U desires a time point to be displayed in the wearable apparatus 101 as a function of a wristwatch. In this case, the information processing terminal 102 transmits the display setting change information 513 including data for identifying the time point to the wearable apparatus 101, and thus the wearable apparatus 101 can display the time point in the first display region 521.

The item candidates 1602 preferably include a lap. It is assumed that the user U desires a running time in a certain section to be displayed in the wearable apparatus 101 as a lap. In this case, the information processing terminal 102 transmits the display setting change information 513 including data for identifying the lap to the wearable apparatus 101, and thus the wearable apparatus 101 can display the running time in the certain section in the first display region 521 as a lap.

The information processing terminal 102 preferably displays an image in which an image indicating the content included in the display setting information 511 is superimposed on a simulation image simulating the wearable apparatus 101 on the touch panel 405 as a display screen. Consequently, as a simulation image is used to display an image using the simulation image, the image closer to a state of the wearable apparatus 101 of when the display setting information 511 is changed is displayed. Therefore, the user U views the image displayed on the touch panel 405, and thus the user U can more easily imagine a state of the wearable apparatus 101 of when the display setting information 511 is changed. The user U may carry a plurality of wearable apparatuses 101. In this case, if appearances of the plurality of respective wearable apparatuses 101 are different from each other, simulation images of the respective wearable apparatuses 101 are also different from each other. Therefore, the user U views images using the simulation images, and can thus easily understand which wearable apparatus 101 is currently being set.

The information processing terminal 102 preferably sets a display aspect of a simulation image by using a display aspect included in the display setting information 511. Consequently, as a simulation image after being set is used, an image closer to a state of the wearable apparatus 101 of when the display setting information 511 is changed is displayed. Therefore, the user U views the image displayed on the touch panel 405, and can thus more easily imagine a state of the wearable apparatus 101 of when the display setting information 511 is changed than in a case where an image simulating a display aspect is not displayed. More specifically, it is assumed that the user U sets a certain background color as a display aspect of a display screen of the wearable apparatus. In this case, the information processing terminal 102 displays an image in which an image indicating the content included in the display setting information 511 is superimposed on a simulation image including the certain background color. In a case where the certain background color is close to a color of text indicating the content included in the display setting information 511, the user U views the image displayed on the touch panel 405, and can aware that color arrangement in setting after being changed is hard to view.

### B. Modification Examples

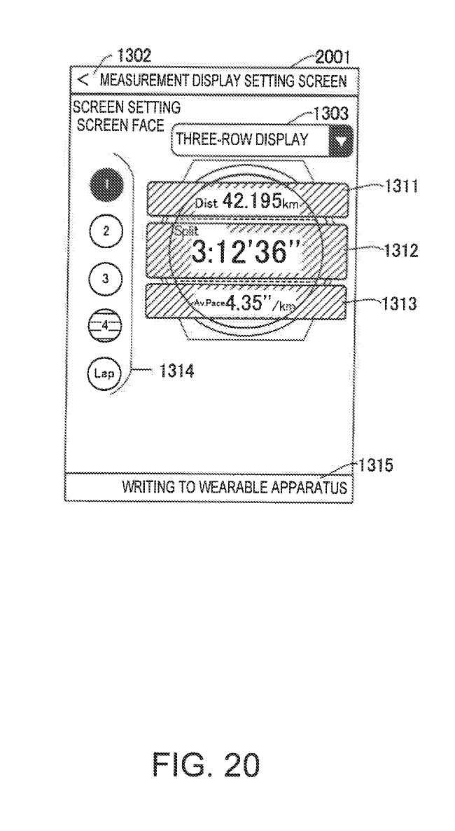

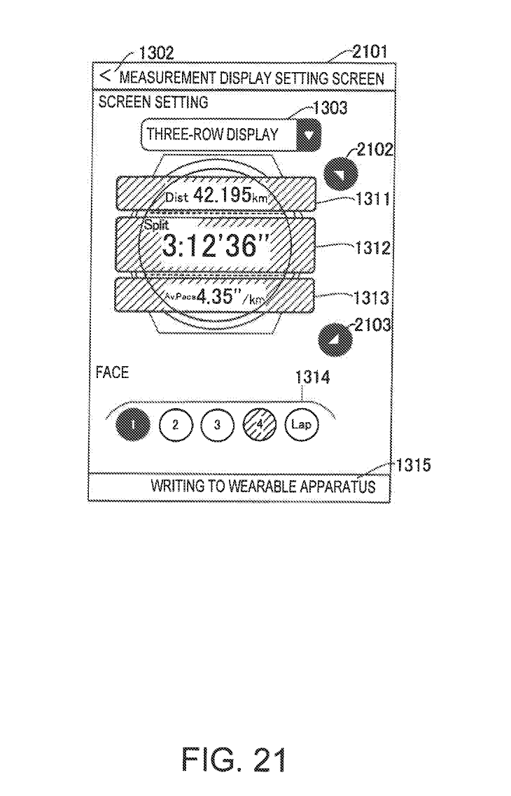

Hereinafter, as modification examples, modification examples of the measurement display setting screen 1301 illustrated in FIG. 13 will be described with reference to FIGS. 20 and 21.

FIG. 20 is a diagram illustrating first Modification Example of a measurement display setting screen. A measurement display setting screen 2001 illustrated in FIG. 20 is in a state in which the buttons indicating the respective faces in the face switching region 1314 are arranged along the Y direction of the wearable apparatus 101 as first Modification Example compared with the measurement display setting screen 1301. As mentioned above, the buttons indicating the respective faces in the face switching region 1314 are arranged along the Y direction of the wearable apparatus 101, and thus the respective faces can be switched with the buttons arranged in the Y direction as in the first operation button 111 or the third operation button 113, so as to be able to be close to an UI of the wearable apparatus 101. A button indicating the face “4” in the measurement display setting screen 2001 is shaded with horizontal lines, and the shading with the horizontal lines indicates a face with which the wearable apparatus 101 does not cope.

FIG. 21 is a diagram illustrating second Modification Example of a measurement display setting screen. A measurement display setting screen 2101 illustrated in FIG. 20 includes a button 2102 simulating the first operation button 111 and a button 2103 simulating the third operation button 113 as second Modification Example compared with the measurement display setting screen 1301. In a case where one of the buttons 2102 and 2103 is pressed, the CPU 400 performs switching to a face corresponding to the pressed button, and displays the display content change menu 1303 and the display regions 1311 to 1313 corresponding to the face after being switched.

As another modification example, in a case where switching, addition, or deletion of a display screen is performed, for example, in any of the processes in steps S704 to S706, the CPU 400 may transmit information indicating orders of display screens after any process, to the wearable apparatus 101. The wearable apparatus 101 may display the display screens in the orders of display screens after any process on the basis of the received information. In a case where information in a single display screen is changed in any of the processes in steps S904 to S906, the CPU 400 may transmit information indicating the changed information in the single display screen to the wearable apparatus 101. The wearable apparatus 101 may display the single screen in a changed state for several seconds.

A location where the wearable apparatus 101 is mounted is not limited to the wrist. For example, the wearable apparatus 101 may be mounted on other parts of the user U, such as the ankle. The wearable apparatus 101 may be a head mounted display (HMD). A setting target in the display setting method in the invention is not limited to the wearable apparatus 101. For example, the setting target may be an electronic apparatus having a display unit. The electronic apparatus may be, for example, a car navigation apparatus, a calculator, a game machine, or a video camera. In FIG. 1, the information processing terminal 102 is described as a smart phone or a tablet terminal, but is not limited thereto. For example, the information processing terminal 102 may be a personal computer (PC). The user U of the information processing terminal 102 and the user U of the wearable apparatus 101 may or may not be the same as each other. An example in which the user U of the information processing terminal 102 and the user U of the wearable apparatus 101 are different from each other is a case where a purchaser of the wearable apparatus 101 asks a support member who is a developer of the wearable apparatus 101 for setting of a display screen of the wearable apparatus 101. In this case, the user U of the information processing terminal 102 is the support member who is a developer of the wearable apparatus 101.

Although not illustrated in FIG. 3, the wearable apparatus 101 may include a touch sensor as an operation unit instead of the operation buttons 111 to 115, and may include both of the operation buttons 111 to 115 and the touch sensor. Here, the touch sensor is a sensor detecting a touch operation of the user U. The touch sensor may employ, for example, a resistive film type, a surface acoustic wave type, or an electrostatic capacitance type. The wearable apparatus 101 may include an azimuth sensor (geomagnetic sensor), an atmospheric pressure sensor, a temperature sensor, and a gyro sensor as sensors other than the acceleration sensor 307 and the pulse sensor 309. The information processing terminal 102 may dispose display screens correlated with the number of operations on the operation unit of the wearable apparatus 101 in a display setting screen. For example, in a case where the wearable apparatus 101 includes a touch sensor, the information processing terminal 102 displays a plurality of display screens to be disposed in correlation with the number of operations on the touch sensor. Therefore, a plurality of display screens and the number of operations on the touch sensor performed by the user U can be checked by the user U in a single screen, and can thus be presented to the user U to be easily understood. In a case where there are a plurality of operation units, the information processing terminal 102 may display by which operation unit the plurality of display screens are switched in a display setting screen. For example, in a case where the wearable apparatus 101 includes a touch sensor, the information processing terminal 102 may display an image based on wording indicating that a plurality of display screens are switched with the touch sensor in a display setting screen.

Consequently, the user U can understand that a plurality of display screens are switched with the touch sensor in a use state of the wearable apparatus 101, and can thus set the wearable apparatus 101 while imagining a use state of the wearable apparatus 101.

The number of operation buttons of the wearable apparatus 101 is not limited to five in the embodiment, and may be smaller than five, and may be larger than five. Arrangement of operation buttons of the wearable apparatus 101 is not limited to the positions in the embodiment. A function cooperating with the operation buttons 111 to 115 is not limited to the example in the embodiment. For example, in a case where the first operation button 111 is pressed, the wearable apparatus 101 displays an activity amount display screen, but may display a workout display screen.

In FIG. 2, in a case where the first operation button 111 is pressed in a state in which the activity amount display screen 133 is displayed, screen transition in which the wearable apparatus 101 returns to a state of displaying the watch screen 200 has been described, but the screen transition may be omitted. For example, even if the first operation button 111 is pressed, the wearable apparatus 101 may be maintained in a state of displaying the activity amount display screen 133 without returning to a state of displaying the watch screen 200. In this case, for example, in a case where the third operation button 113 is pressed, the wearable apparatus 101 may perform screen transition of displaying the activity amount display screen 132.

Similarly, in FIG. 11, in a case where the first operation button 111 is pressed by the user U when the watch screen is displayed on the display unit 121, screen transition in which the activity amount display screen for “Summary2” is displayed on the display unit 121 has been described, but the screen transition may be omitted. In a case where the screen transition is omitted, the respective activity amount display simulation screens 1112 to 1114 and the watch simulation screen 1111 are arranged in order from the top of the activity amount display setting screen 1101 in the activity amount display setting screen 1101.

Similarly, in FIG. 12, in a case where the third operation button 113 is pressed by the user U when the screen in which “triathlon” is displayed is displayed on the display unit 121, screen transition in which the watch screen is displayed on the display unit 121 has been described, but the screen transition may be omitted. In a case where the screen transition is omitted, the watch simulation screen 1111 and the respective workout display simulation screens 1202 to 1204 are arranged in order from the top of the workout display setting screen 1201 in the workout display setting screen 1201.

The modification examples regarding the above-described three drawings have similarity in that the same display screen is not repeated when any of the operation buttons 111 to 115 is repeatedly pressed. According to the modification examples, the user U can easily understand to what degree the current display screen is separated from a default screen such as the watch screen, that is, a position of the current display screen in a hierarchy of display screens including the watch screen, the activity amount display screen, and the workout display screen.

In the embodiment, the wearable apparatus 101 performs various processes by using a signal from a GPS satellite, but may use a signal from a positioning satellite of a global navigation satellite system (GNSS) other than the GPS, or a positioning satellite other than the GNSS. For example, a satellite signal from one, or two or more satellite positioning systems such as a wide area augmentation system (WAAS), a European geostationary-satellite navigation overlay service (EGNOS), a quasi zenith satellite system (QZSS), a global navigation satellite system (GLONASS), GALILEO, a Beidou navigation satellite system (BeiDou) may be used.

The invention may also be regarded as a computer program configured to cause the information processing terminal 102 to function as each unit of the information processing terminal 102 described above or a computer readable recording medium on which the computer program is recorded, and may also be regarded as a computer program configured to cause one or more computers in the above-described display system to function as each unit of the display system described above or a computer readable recording medium on which the computer program is recorded. The recording medium is, for example, a non-transitory recording medium, and may include not only an optical recording medium such as a CD-ROM but also well-known any recording medium such as a semiconductor recording medium or a magnetic recording medium. The invention is also specified as a display setting method according to each of the above-described aspects.

What is claimed is:

1. A display setting method of setting one or a plurality of display screens by using an information processing terminal which is able to communicate with a wearable apparatus which displays the one or plurality of display screens on the basis of measured data obtained in a sensor, the method comprising:
causing the information processing terminal to
acquire display setting information regarding the one or plurality of display screens from the wearable apparatus;
display a display setting screen for changing the content of the one or plurality of display screens on the basis of the display setting information;
generate display setting change information on the basis of a user's change operation on the display setting screen; and
transmit the display setting change information to the wearable apparatus from the information processing terminal.

2. The display setting method according to claim 1,
wherein the display setting information is information regarding at least one of the content and a display aspect of the one display screen or each of the plurality of display screens.

3. The display setting method according to claim 1,
wherein the display setting information is information regarding at least one of orders, the content, and display aspects of the plurality of display screens which are switched according to the user's operation on an operation unit of the wearable apparatus.

4. The display setting method according to claim 1,
wherein the display setting information includes orders of the plurality of display screens which are switched according to the user's operation on an operation unit of the wearable apparatus, and
wherein the plurality of display screens which are switched according to operations performed by the user are disposed in correlation with orders of the operations performed by the user in the display setting screen.

5. The display setting method according to claim 4,
wherein the operation unit of the wearable apparatus includes at least one of a button or a touch sensor, and
wherein the plurality of display screens are disposed in correlation with the number of operating the operation unit in the display setting screen.

6. The display setting method according to claim 1,
wherein, in a case where a change operation regarding at least one of orders, the content, and display aspects of the plurality of display screens is received, the display setting change information is generated.

7. The display setting method according to claim 1,
wherein the wearable apparatus measures a plurality of items indicating a state of the user,
wherein the one display screen or each of the plurality of display screens includes a first display region and a second display region,
wherein at least one item selected from among the plurality of items is displayed in the first display region,
wherein at least one item which is different from the item displayed in the first display region and is selected from among the plurality of items is displayed in the second display region,
wherein the display setting information includes first identification data for identifying the item displayed in the first display region and second identification data for identifying the item displayed in the second display region,
wherein the information processing terminal displays an image to be displayed in the first display region on the basis of the first identification data,
wherein the information processing terminal displays an image to be displayed in the second display region on the basis of the second identification data,
wherein the information processing terminal displays an image based on a plurality of item candidates of items which are able to be displayed in the first display region according to an operation on an operation unit of the information processing terminal,
wherein the first identification data is updated such that an item selected from among the plurality of item candidates according to an operation on the operation unit of the information processing terminal is identified, and
wherein the display setting change information including the updated first identification data is transmitted to the wearable apparatus.

8. The display setting method according to claim 7,
wherein the plurality of item candidates include at least one of an item regarding activity of the user or an item regarding an index obtained by analyzing the activity of the user.

9. The display setting method according to claim 7,
wherein a time point is able to be displayed in the first display region, and
wherein the plurality of item candidates include a time point.

10. The display setting method according to claim 7,
wherein a lap is able to be displayed in the first display region,
wherein the lap is a movement distance of the wearable apparatus per unit time, the time required for movement of the wearable apparatus per unit distance, or a number of each of a plurality of predefined running sections, and
wherein the plurality of item candidates include the lap.

11. The display setting method according to claim 1,
wherein the display setting information is information regarding the content of the one or plurality of display screens, and
wherein a simulation image simulating the wearable apparatus and an image indicating the content included in the display setting information are displayed.

12. The display setting method according to claim 11,
wherein the display setting information is information regarding the content and a display aspect of the one display screen or each of the plurality of display screens, and
wherein a display aspect of the simulation image is set by using a display aspect included in the display setting information.

13. A program for setting one or a plurality of display screens by using an information processing terminal which is able to communicate with a wearable apparatus which displays the one or plurality of display screens on the basis of measured data obtained in a sensor, the program causing the information processing terminal to function as:
an acquisition unit that acquires display setting information regarding the one or plurality of display screens from the wearable apparatus;
a display unit that displays a display setting screen for changing the content of the one or plurality of display screens on the basis of the display setting information;
a generation unit that generates display setting change information on the basis of a user's change operation on the display setting screen; and
a transmission unit that transmits the display setting change information to the wearable apparatus from the information processing terminal.

14. A system comprising:
a wearable apparatus that displays one or plurality of display screens on the basis of measured data obtained in a sensor; and
an information processing terminal that is able to communicate with the wearable apparatus,
wherein the information processing terminal
acquires display setting information regarding the one or plurality of display screens from the wearable apparatus,
displays a display setting screen for changing the content of the one or plurality of display screens on the basis of the display setting information,
generates display setting change information on the basis of a user's change operation on the display setting screen, and
transmits the display setting change information to the wearable apparatus from the information processing terminal, and
wherein the wearable apparatus displays the one or plurality of display screens by using the display setting change information.
